(19) United States
(12) Patent Application Publication
(10) Pub. No.: US 2025/0120417 A1
(43) Pub. Date: Apr. 17, 2025

(54) FEED ADDITIVE COMPOSITIONS AND METHODS FOR USING THE SAME

(71) Applicants: INTERNATIONAL N&H DENMARK APS, Kongens Lyngby (DK); DUPONT NUTRITION BIOSCIENCES APS, Kongens Lyngby (DK); DANISCO FRANCE SAS, Dange Saint Romain (FR); DANISCO UK LTD, Marlborough Wiltshire (GB); NUTRITION & BIOSCIENCES USA 4, INC., Wilmington, DE (US)

(72) Inventors: Marion BERNARDEAU, Caen (FR); Michael PERRY, Downingtown, PA (US); Charlotte Horsmans POULSEN, Brabrand (DK); Alexander BEKELE-YITBAREK, Wilmington, DE (US); Kirsty GIBBS, Cheshire (GB); Gerda SAXER QUANCE, Kennett Square, PA (US); Jeffrey MEISCH, Landenberg, PA (US); Adam ROSENTHAL, Wilmington, DE (US); Melanie BRENNAN, Wilmington, DE (US)

(21) Appl. No.: 18/695,602

(22) PCT Filed: Sep. 27, 2022
(86) PCT No.: PCT/US2022/044820

§ 371 Date: Mar. 26, 2024

Related U.S. Application Data
(60) Provisional application No. 63/397,189, filed on Aug. 11, 2022.
(60) Provisional application No. 63/248,668, filed on Sep. 27, 2021.
(60) Provisional application No. 63/248,657, filed on Sep. 27, 2021.

(51) Int. Cl. A23K 10/18; A23K 20/105; A23K 20/111; A23K 20/174; A23K 20/189; A23K 50/30; A23K 50/60; A23K 50/75

(52) U.S. Cl. CPC A23K 10/18; A23K 20/105; A23K 20/111; A23K 20/174; A23K 20/189; A23K 50/30; A23K 50/60; A23K 50/75

(57) ABSTRACT

Provided herein, inter alia, are feed or feed additive compositions comprising direct fed microbials (DFMs) and other substances as well as methods for making and using the same for the improvement of a subject's performance and maintenance of a balanced gut microbiome.

### CROSS-REFERENCE TO RELATED APPLICATIONS

This application claims priority to U.S. Provisional Patent Application No. 63/248,657, filed Sep. 27, 2021, U.S. Provisional Patent Application No. 63/248,668, filed Sep. 27, 2021, and U.S. Provisional Patent Application No. 63/397,189, filed Aug. 11, 2022, the disclosure of each of which is incorporated by reference herein in its entirety.

### FIELD OF THE INVENTION

Provided herein, inter alia, are methods and compositions for treating and preventing necrotic enteritis and/or coccidiosis in a subject in need thereof.

### BACKGROUND

Necrotic enteritis (NE) is estimated to cost the global poultry industry approximately $6 Billion USD annually (Poultry Federation, 2019). NE impacts 40% of broilers globally, costing approximately $0.050-0.063 USD per bird. There are different levels of NE severity, from acute clinical disease associated with 10-25% mortality to more chronic sub-clinical infection resulting in hindered bird growth performance (bodyweight gain and feed conversion ratios) and low mortality (0.5-2%).

Antibiotic resistance is on the WHO's top ten list of threats to global human health in 2019, particularly in the context of large-scale fanning and meat production. According to the U.S. Food and Drug Administration, 80% of antibiotics sold are used for livestock. In many countries, a ban on antibiotic use in livestock production has already been implemented and in others consumer pressure is forcing the industry to stop using antibiotic growth promoters (AGP). The abrupt cessation of the use of antibiotic growth promoters has put the livestock industry under high pressure.

The trend towards global removal of antibiotics in poultry systems continues to create significant challenges for nutritionists and veterinarians. NE and coccidiosis are the top two concerns for reduced antibiotic production. Without the antibiotic line of defense animal susceptibility to gut health related diseases (both clinical and subclinical) is increased. This is translated into poor animal performance. Despite many parts of the world being AGP free for over a decade (e.g., the E.U) livestock producers continue to be frustrated by the lack of consistent and reliable antibiotic replacements.

Current feed additives such as acidifiers, minerals, prebiotics, direct fed microbials (DFMs; a.k.a. probiotics), nucleotides, and plant extracts (Liu et al., 2018, Animal Nutrition, 4: 113-125)) to replace AGP in livestock production all show a much lower efficacy (less than 50%) than antibiotics (ca 95%). There is, therefore, a large unmet need to find alternatives to antibiotics, which can maintain livestock health and performance without the accompanying negative effects associated with increased antibiotic resistance.

The subject matter disclosed herein addresses this need and provides additional benefits as well.

### SUMMARY

Provided herein, inter alia, are feed or feed additive compositions comprising direct fed microbials (DFMs) and other substances as well as methods for making and using the same for the improvement of a subject's performance and maintenance of a healthy and/or balanced gut microbiome.

Accordingly, in some aspects, provided herein are feed additive compositions comprising or consisting essentially of a direct fed microbial (DFM) comprising Bifidobacterium animalis subsp. lactis and/or a Lactobacillus acidophilus. In some embodiments, the feed additive compositions further comprise or consist essentially of an osmoregulator. In some embodiments of any of the embodiments disclosed herein, the feed additive compositions further comprise or consist essentially of at least one essential oil. In some embodiments of any of the embodiments disclosed herein, the feed additive compositions further comprise or consist essentially of one or more enzyme selected from the group consisting of protease, xylanase, beta-glucanase, phytase, and amylase. In some embodiments, the enzyme is encapsulated or in the form of a granule or is freeze dried. In some embodiments of any of the embodiments disclosed herein, the feed additive compositions comprise or consist essentially of Bifidobacterium animalis subsp. lactis strain B1-04. In some embodiments of any of the embodiments disclosed herein, the feed additive compositions comprise or consist essentially of Lactobacillus acidophilus strain NCFM. In some embodiments of any of the embodiments disclosed herein, the osmoregulator comprises betaine. In some embodiments of any of the embodiments disclosed herein, the at least one essential oil comprises cinnamaldehyde, carvacol, and/or thymol. In some embodiments of any of the embodiments disclosed herein, the feed additive compositions further comprise or consist essentially of at least one additional DFM. In some embodiments of any of the embodiments disclosed herein, the feed additive compositions further comprise or consist essentially of one or more of aspartic acid (aspartate), ornithine, arginine, phosphate, acetate, and/or a B vitamin. In some embodiments of any of the embodiments disclosed herein, the B vitamin is one or more of vitamin B₁, B₆, and/or B₁₂. In some embodiments of any of the embodiments disclosed herein, at least one component of the composition is formulated for water line delivery.

In another aspect, provided herein is an animal feed or premix comprising any of the feed additive compositions disclosed herein.

In further aspects, provided herein is a method for treating or preventing necrotic enteritis in a subject in need thereof, comprising administering an effective amount of any of the feed additive compositions disclosed herein or any of the animal feeds or premixes disclosed herein to the subject. In some embodiments, the subject is poultry or swine. In some embodiments of any of the embodiments disclosed herein, the poultry is a broiler or a layer or a turkey. In some embodiments of any of the embodiments disclosed herein, the swine is a piglet, a growing pig, or a sow. In some embodiments of any of the embodiments disclosed herein, said method reduces or prevents necrotic enteritis intestinal lesions. In some embodiments of any of the embodiments disclosed herein, said method further reduces feed conversion ratio, increases feed efficiency, reduces mortality, increases final slaughter weight, or increases weight gain in the subject compared to a subject that has not been administered an effective amount of any of the feed additive compositions disclosed herein or any of the animal feeds or premixes disclosed herein. In some embodiments, the subject has clinical or subclinical necrotic enteritis. In some embodiments of any of the embodiments disclosed herein, said method further reduces expression of Clostridium perfringens necrotic enteritis B-like toxin (NetB). In some embodiments of any of the embodiments disclosed herein, the feed additive composition is administered by water line. In some embodiments of any of the embodiments disclosed herein, said administration is performed without co-administration of an antibiotic to the subject.

In yet further aspects, provided herein is a method for treating or preventing coccidiosis in a subject in need thereof, comprising administering an effective amount of any of the feed additive compositions disclosed herein or any of the animal feeds or premixes disclosed herein to the subject. In some embodiments, the subject is poultry. In some embodiments of any of the embodiments disclosed herein, the poultry is a broiler or a layer. In some embodiments of any of the embodiments disclosed herein, said method reduces feed conversion ratio, increases feed efficiency, reduces mortality, increases final slaughter weight, or increases weight gain in the subject. In some embodiments of any of the embodiments disclosed herein, said method reduces one or more intestinal Eimeria species. In some embodiments of any of the embodiments disclosed herein, at least one component of the feed additive composition is administered by water line.

In another aspect, provided herein is a method for decreasing necrotic enteritis B-like toxin (NetB) expression in Clostridium perfringens comprising contacting a C. perfringens cell with one or more of aspartic acid (aspartate), ornithine, arginine, phosphate, acetate, a B vitamin, and/or the secretomes of one or both of B. animalis or L. acidophilus. In some embodiments, the B vitamin is one or more of vitamin B₁, B₆, and/or B₁₂. In some embodiments of any of the embodiments disclosed herein, the B. animalis is Bifidobacterium animalis subsp. lactis strain B1-04 and/or the L. acidophilus is Lactobacillus acidophilus strain NCFM. In some embodiments of any of the embodiments disclosed herein, the C. perfringens cell is located in the gut of poultry. In some embodiments, the poultry is a chicken, quail, duck, goose, emu, ostriche, pheasant, or turkey. In some embodiments, the chicken is a broiler or a layer. In some embodiments of any of the embodiments disclosed herein, the method further comprises contacting the C. perfringens cell with one or more of an osmoregulator and/or at least one essential oil. In some embodiments, the osmoregulator comprises betaine. In some embodiments of any of the embodiments disclosed herein, the at least one essential oil comprises cinnamaldehyde, carvacol, and/or thymol.

In further aspects, provided herein is a method for decreasing necrotic enteritis B-like toxin (NetB) expression in Clostridium perfringens in a subject in need thereof comprising or consisting essentially of administering an effective amount of any of the feed additive compositions disclosed herein or any of the animal feed or premix compositions disclosed herein, wherein the C. perfringens cell is located in the gut of the subject. In some embodiments, the subject is poultry or swine. In some embodiments of any of the embodiments disclosed herein, the poultry is a broiler or a layer or a turkey. In some embodiments of any of the embodiments disclosed herein, the swine is a piglet, a growing pig, or a sow. In some embodiments of any of the embodiments disclosed herein, said method reduces or prevents necrotic enteritis intestinal lesions. In some embodiments of any of the embodiments disclosed herein, said method further reduces feed conversion ratio, increases feed efficiency, reduces mortality, increases final slaughter weight, or increases weight gain in the subject compared to a subject that has not been administered an effective amount of any of the feed additive compositions disclosed herein or any of the animal feed or premix compositions disclosed herein. In some embodiments, the subject has clinical or subclinical necrotic enteritis. In some embodiments of any of the embodiments disclosed herein, the feed additive composition is administered by water line. In some embodiments of any of the embodiments disclosed herein, said administration is performed without co-administration of an antibiotic to the subject.

Each of the aspects and embodiments described herein are capable of being used together, unless excluded either explicitly or clearly from the context of the embodiment or aspect.

Throughout this specification, various patents, patent applications and other types of publications (e.g., journal articles, electronic database entries, etc.) are referenced. The disclosure of all patents, patent applications, and other publications cited herein are hereby incorporated by reference in their entirety for all purposes.

### BRIEF DESCRIPTION OF THE DRAWINGS

FIG. 1A depicts a boxplot representing the average final slaughter bodyweights of birds (D42) per treatment of the study. Each dot is indicative of a replicate pen within a treatment. Significance is determined by P<0.05 compared to the Challenged control (CC). FIG. 1B depicts a boxplot representing the average feed conversion ratios (FCR) of birds (D42) per treatment of the study. Each dot is indicative of a replicate pen within a treatment. Significance is determined by P<0.05 compared to the Challenged control (CC).

FIG. 2A depicts individual bird necrotic enteritis lesion scores based on 0-4 scoring system) by treatment on D21. Twenty-four birds per treatment were evaluated. The treatments with the fewest NE lesions contained Betaine, EO and DFM only. FIG. 2B depicts a boxplot representing the average bodyweights of birds per treatment on D28. Each dot is indicative of a replicate pen within a treatment. Significance is determined by P<0.05 compared to the Challenged control (CC). FIG. 2C depicts a boxplot representing the average final slaughter bodyweights of birds per treatment (D35). Each dot is indicative of a replicate pen within a treatment. Significance is determined by P<0.05 compared to the Challenged control (CC). FIG. 2D depicts a boxplot representing average serum FITC-Dextran levels (μg/mL) across treatments as a way of determining gut permeability. One bird from each replicate pen was evaluated, providing 8 birds per treatment. Each dot is representative of a bird. Significance is determined by P<0.05 compared to the Challenged control (CC). FIG. 2E depicts a boxplot representing the average Feed conversion ratios (FCRs) of birds per treatment (D42). Each dot is indicative of a replicate pen within a treatment. Significance is determined by P<0.05 compared to the Challenged control (CC).

FIG. 3A depicts enumeration of C. perfringens as determined using qPCR and expressed as Log 10 CFU/intestinal swab at D21 of the study. FIG. 3B depicts the expression of netB gene in intestinal swabs collected at D21 of the study and expressed as log 10 gene copy number per ileal swab.

FIG. 4 depicts a grid showing the setup of the Clostridium perfringens inhibition assay described in Example 4.

FIG. 5 depicts a series of bar graphs showing percent inhibition of Clostridium perfringens by B1-04 and essential oils.

FIG. 6 depicts a series of bar graphs showing percent inhibition of Clostridium perfringens by NCFM and essential oils.

FIG. 7A is a heatmap of marker gene expression (z-score of log-transformed values) from individual C. perfringens cells grown unaerobically in minimal M9 media organized into 10 clusters. FIG. 7B depicts a schematic of the final steps in arginine biosynthesis. FIG. 7C depicts a Western blot of NetB toxin secreted into the growth media by C. perfringens cultures grown in BHI alone or BHI with the presence of aspartate, ornithine or arginine. FIG. 7D depicts a UMI plot showing single cell clustering of C. perfringens culture grown either in BHI alone (light) or BHI plus aspartate (dark). FIG. 7E depicts the cytotoxicity of conditioned media from C. perfringens cultures grown with or without aspartate, ornithine or arginine on human epithelial HT-29 cells.

FIG. 8 depicts Western blots detecting NetB toxin production when ammonium phosphate, sodium acetate, or B vitamins (Vitamin B1, B6, and B12) were added to a culture of Clostridium perfringens as compared to extra cellular toxin detected when grown in un-supplemented growth media (BHI).

FIG. 9A (top) depicts a UMI plot showing single cell clustering of C. perfringens culture grown either in BHI alone (light), BHI plus 2.5% secretome of Bifidobacterium animalis susb. lactis (medium) or BHI plus 5% secretome of Bifidobacterium animalis susb. lactis (dark) and (bottom) complementary C. perfringens single cell expression of netB gene grown in BHI alone, BHI plus 2.5% secretome of Bifidobacterium animalis susb. lactis or BHI plus 5% secretome of Bifidobacterium animalis susb. lactis. FIG. 9B (top) depicts a UMI plot showing single cell clustering of C. perfringens culture grown either in BHI alone (light) or BHI plus Lactobacillus acidophilus secretome (dark) and (bottom) complementary C. perfringens single cell expression of netB gene grown in BHI or BHI plus L. acidophilus secretome. FIG. 9C depicts a Western blot of NetB toxin secreted into the growth media by C. perfringens cultures grown in BHI alone or BHI with the presence of Bifidobacterium animalis susb. lactis secretome or L. acidophilus secretome. FIG. 9D depicts the cytotoxicity of conditioned media from C. perfringens cultures grown with or without secretomes Bifidobacterium animalis susb. lactis, L. acidophilus or a combination of both secretomes on human epithelial HT-29 cells.

### DETAILED DESCRIPTION

Clostridium perfringens is the main causative agent of avian necrotic enteritis (NE), an enteric disease of poultry that was first described in 1961. NE in chickens manifests as an acute or chronic enterotoxemia. The acute disease results in significant levels of mortality due to the development of extensive necrotic lesions in the gut wall, whereas the chronic disease leads to a significant loss of productivity and welfare. It has been estimated that the disease results in damages of several billion US-Dollars per year for the poultry industry.

C. perfringens is commonly found in the gastrointestinal tract of poultry. C. perfringens is a Gram-positive, rod-shaped, spore forming, oxygen-tolerant anaerobe. C. perfringens are classified into five toxin types (A, B, C, D and E), based on the production of four suspected major toxins (alpha, beta, epsilon and iota). While type A is consistently recovered from intestines of chicken, the other types are less common.

Early studies on NE suggested that the main virulence factor involved in the disease was secreted by the bacteria, which led to the proposal that a phospholipase C enzyme, called alpha-toxin, was the major toxin involved in pathogenesis. But recent studies showed that alpha-toxin seems not to be an essential virulence factor since alpha toxin-minus mutant strains were capable of causing NE, which questions the role of alpha-toxin in the disease in general. In subsequent studies, the novel pore forming toxin, NetB, has been suggested to play a major key role in the development of this disease.

Coccidiosis remains the number one predisposing factor to NE outbreaks. Poultry producers, who can do so, typically use coccidiosis control programs to avoid NE outbreaks. Producers continue to be frustrated by the lack of consistency of cocci vaccinations, and producers must rotate ionophore/chemical programs to avoid the development of resistance. Therefore, any solution developed for NE control should be assessed in models using Eimeria, the causative parasite of coccidiosis, as a predisposition for NE, evaluated for anti-Eimeria effects in vitro and in vivo (lesion scoring).

The inventors of the instant application have surprisingly found that certain active agents, which when used in combination(s), interfere directly with the infection biology of Clostridium perfringens, the causative agent of NE in avian species and/or indirectly with the host and/or its endogenous gut microbiota to modulate the infection biology of C. perfringens. The invention reduces C. perfringens levels within the gut during times of challenge, reduces quorum sensing and thus reduces toxin expression (specifically, reduces the amount of necrotic enteritis B-like toxin (NetB) produced by C. perfringens cells), reduces the development of NE intestinal lesions when birds are predisposed to NE (through diet or Coccidiosis exposure) or are challenged with NE. Furthermore, the disclosed invention, reduces local intestinal inflammation and supports/maintains gut integrity during times of NE challenge, subsequently leading to reductions in NE mortality, and improvements in bird performance (bodyweight gain and/or feed conversion ratios) in the presence of a NE challenge. The invention also supports a positive gut microbiota.

### I. Definitions

The terms “animal” and “subject” are used interchangeably herein and refer to non-ruminant animals, i.e., mono-gastric animals. Examples of mono-gastric animals include, but are not limited to, pigs and swine, such as piglets, growing pigs, sows; and poultry. The term “poultry,” as used herein, means domesticated birds kept by humans for their eggs, their meat or their feathers. These birds are most typically members of the superorder Galloanserae, especially the order Galliformes which includes, without limitation, chickens, quails, ducks, geese, emus, ostriches, pheasant, and turkeys. In a further embodiment, the animal is a chicken, such as a broiler or a layer. In some embodiments, the subject or animal is not a human.

As used herein, “prevent,” “preventing,” “prevention” and grammatical variations thereof refers to a method of partially or completely delaying or precluding the onset or recurrence of a disorder or condition (such as necrotic enteritis) and/or one or more of its attendant symptoms or barring an animal from acquiring or reacquiring a disorder or condition or reducing an animal's risk of acquiring or reacquiring a disorder or condition or one or more of its attendant symptoms.

As used herein, the term “reducing” in relation to a particular trait, characteristic, feature, biological process, or phenomena refers to a decrease in the particular trait, characteristic, feature, biological process, or phenomena. The trait, characteristic, feature, biological process, or phenomena can be decreased by 5%, 10%, 15%, 20%, 25%, 30%, 35%, 40%, 45%, 50%, 55%, 60%, 65%, 70%, 75%, 80%, 85%, 90%, 95%, 100% or greater than 100%.

As used herein “administer” or “administering” is meant the action of introducing one or more microbial strain, an exogenous feed enzyme, feed additive, and/or a strain to an animal, such as by feeding or by gavage. In one embodiment, a composition is administered to a subject via a water line, from which the subject drinks.

As used herein, “effective amount” means a quantity of a substance (for example, betaine, a direct fed microbial (DFM), or an essential oil (EO)) to improve one or more metrics in an animal. Improvement in one or more metrics of an animal (such as, without limitation, any of improved feed conversion ratio (FCR); improved weight gain; improved feed efficiency; improved gut microbiome status (i.e. more healthy (“good”) bacterial and/or less unhealthy (“bad”) bacteria; and/or improved carcass quality can be measured as described herein or by other methods known in the art. An effective amount can be administered to the animal by providing ad libitum access to feed and/or water containing the substance. Additionally, substances (e.g., betaine, a DFM, or an EO) can also be administered in one or more doses. Also, in some embodiments, an effective amount of some substances (e.g., betaine or an EO) can be administered in feed or as a component of a feed and other substances (e.g. one or more DFMs) can be administered by water line).

The term “pathogen” as used herein means any causative agent of disease. Such causative agents can include, but are not limited to, bacterial, viral, fungal causative agents and the like.

As used herein, “subclinical” means without clinical manifestations; said of the early stage(s) of an infection or other disease (for example, necrotic enteritis) before symptoms and signs become apparent or detectable by clinical examination or laboratory tests, or of a very mild form of an infection or other disease (for example, necrotic enteritis).

A “feed” and a “food,” respectively, means any natural or artificial diet, meal or the like or components of such meals intended or suitable for being eaten, taken in, digested, by a non-human animal and a human being, respectively. As used herein, the term “food” is used in a broad sense—and covers food and food products for humans as well as food for non-human animals (i.e. a feed).

As used herein, the term “feed” is used synonymously herein with “feedstuff.” Feed broadly refers to a material, liquid or solid, that is used for nourishing an animal, and for sustaining normal or accelerated growth of an animal including newborns or young and developing animals. The term includes a compound, preparation, mixture, or composition suitable for intake by an animal (such as, e.g., for poultry such as quail, ducks, turkeys, and chickens). In some embodiments, a feed or feed composition comprises a basal food composition and one or more feed additives or feed additive compositions.

The term “feed additive” as used herein refers to components included for purposes of fortifying basic feed with additional components to promote feed intake, treat or prevent disease, or alter metabolism. In some embodiments, however, the feed additive is formulated for water line delivery to the animal and is not added directly to the feed. Feed additives include pre-mixes. As used herein, the term “feed additive” also refers to a substance which is added to a feed or to water administered in conjunction with a feed. Feed additives may be added to feed for a number of reasons. For instance, to enhance digestibility of the feed, to supplement the nutritional value of the feed, improve the immune defense of the recipient and/or to improve the shelf life of the feed. In some embodiments, the feed additive supplements the nutritional value of the feed and/or improves the immune defense of the recipient. In some embodiments, the feed additive is not for administration to a human.

A “premix,” as referred to herein, may be a composition composed of micro-ingredients such as, but not limited to, one or more of vitamins, minerals, chemical preservatives, antibiotics, fermentation products, and other essential ingredients. Premixes are usually compositions suitable for blending into commercial rations.

The term “performance” as used herein may be determined by the feed efficiency and/or weight gain of the animal and/or by the feed conversion ratio and/or by the digestibility of a nutrient in a feed (e.g., amino acid digestibility or phosphorus digestibility) and/or digestible energy or metabolizable energy in a feed and/or by nitrogen retention and/or by animals' ability to avoid the negative effects of diseases or by the immune response of the subject. Performance characteristics may include but are not limited to: body weight; weight gain; mass; body fat percentage; height; body fat distribution; growth; growth rate; milk production; mineral absorption; mineral excretion, mineral retention; bone density; bone strength; feed conversion rate (FCR); average daily feed intake (ADFI); Average daily gain (ADG) retention and/or a secretion of any one or more of copper, sodium, phosphorous, nitrogen and calcium; amino acid retention or absorption; mineralization, bone mineralization carcass yield and carcass quality.

As used herein, the term “feed efficiency” refers to the amount of weight gain in an animal that occurs when the animal is fed ad-libitum or a specified amount of food during a period of time. By “increased feed efficiency” it is meant that the use of a feed additive composition according the present invention in feed or in drinking water via water line delivery results in an increased weight gain per unit of feed intake compared with an animal fed without said feed additive composition being present.

As used herein, “feed conversion ratio” refers to a measure of a subject's efficiency in converting feed mass into increases of a desired output and is calculated by dividing the mass of the food eaten by the output for a specified period. For example, if an animal is raised for meat (e.g., beef), the output may be the mass gained by the animal. If an animal is raised for another intended purpose (e.g., milk production), the output will be different. The term “feed conversion ratio” may be used interchangeably with the terms “feed conversion rate” or “feed conversion efficiency.” By “lower feed conversion ratio” or “improved feed conversion ratio” it is meant that the use of a feed additive composition in feed results in a lower amount of feed being required to be fed to an animal to increase the weight of the animal by a specified amount compared to the amount of feed required to increase the weight of the animal by the same amount when the feed does not comprise said feed additive composition.

As used herein, “microorganism” or “microbe” refers to a bacterium, a fungus (such as a yeast), a virus, a protozoan, and other microbes or microscopic organisms.

The term “direct-fed microbial” (“DFM”) as used herein is source of live (viable) microorganisms that when applied in sufficient numbers can confer a benefit to the recipient thereof, i.e., a probiotic. A DFM can comprise one or more of such microorganisms such as bacterial strains. Categories of DFMs include Bacillus, Lactic Acid Bacteria and Yeasts. Thus, the term DFM encompasses one or more of the following: direct fed bacteria, direct fed yeast, direct fed yeast and combinations thereof. Bacilli are unique, gram-positive rods that form spores. These spores are very stable and can withstand environmental conditions such as heat, moisture and a range of pH. These spores germinate into active vegetative cells when ingested by an animal and can be used in meal and pelleted diets. Lactic Acid Bacteria are gram-positive cocci that produce lactic acid which are antagonistic to some pathogens. Since Lactic Acid Bacteria appear to be somewhat heat-sensitive, they are typically not used in pelleted diets. Types of Lactic Acid Bacteria include, without limitation, Lactobacillus, Leuconostoc, Pediococcus and Streptococcus.

The terms “probiotic,” “probiotic culture,” and “DFM” are used interchangeably herein and define live microorganisms (including bacteria or yeasts, for example) which, when for example ingested or locally applied in sufficient numbers, beneficially affects the host organism, i.e. by conferring one or more demonstrable benefits (such as a health benefit or balanced gut microbiota benefit) on the host organism such as a digestive and/or performance benefit. Probiotics may improve the microbial balance in one or more mucosal surfaces. For example, the mucosal surface may be the intestine, the urinary tract, the respiratory tract or the skin. The term “probiotic” as used herein also encompasses live microorganisms that can stimulate the beneficial branches of the immune system and at the same time decrease the inflammatory reactions in a mucosal surface, for example the gut. Whilst there are no lower or upper limits for probiotic intake, it has been suggested that at least 10⁶-10¹², for example at least 10⁶-10¹⁰, for example 10⁸-10⁹, colony forming units (cfu) as a daily dose will be effective to achieve the beneficial effects in a subject.

The term “CFU” as used herein means “colony forming units” and is a measure of viable cells in which a colony represents an aggregate of cells derived from a single progenitor cell.

As used herein, a “secretome” means the totality of organic molecules and inorganic elements produced and secreted by a cell. Where growth conditions are indicated, the secretome is the totality of organic molecules and inorganic elements produced and secreted by a cell under those growth conditions. It will be understood that the secretome may be recovered in cellular supernatants and fractions of supernatants thereof.

As used herein, the term “osmoregulator” means a compound which, by balancing osmotic forces between the interior of a cell and the exterior of a cell, aids in the survival of the cell in a highly osmotic environment. In one embodiment, an osmoregulator is betaine.

As used herein the term “betaine” refers to trimethylglycine. The compound is also called trimethylammonioacetate, 1-carboxy-N,N,N-trimethylmethaneaminium, inner salt and glycine betaine. It is a naturally occurring quaternary ammonium type compound having the formula

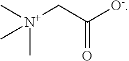

Betaine has a bipolar structure comprising a hydrophilic moiety (COO−) and a hydrophobic moiety (N+) capable of neutralizing both acid and alkaline solutions. In its pure form, betaine is a white crystalline compound that is readily soluble in water and lower alcohols. In the present invention betaine can be used, for example, as an anhydrous form, or as a hydrate or as an animal feed acceptable salt. In one embodiment, when betaine is present, it is present as the free zwitterion. In one embodiment, when betaine is present, it is present as anhydrous betaine. In one embodiment, when betaine is present, it is present as a monohydrate. “Betaine” also includes naturally-derived betaine as well as synthetic betaine.

As used herein an “animal feed acceptable salt” means any non-toxic salt that, upon administration to a recipient, is capable of providing, either directly or indirectly, a compound or a derivative of a compound described herein. Acids commonly employed to form acceptable salts include inorganic acids such as hydrogen bisulfide, hydrochloric, hydrobromic, hydroiodic, sulfuric and phosphoric acid, as well as organic acids such as para-toluenesulfonic, salicylic, tartaric, bitartaric, ascorbic, maleic, besylic, fumaric, gluconic, glucuronic, formic, glutamic, methanesulfonic, ethanesulfonic, benzenesulfonic, lactic, oxalic, para-bromophenylsulfonic, carbonic, succinic, citric, benzoic and acetic acid, and related inorganic and organic acids. Such animal feed acceptable salts thus include sulfate, pyrosulfate, bisulfate, sulfite, bisulfite, phosphate, monohydrogenphosphate, dihydrogenphosphate, metaphosphate, pyrophosphate, chloride, bromide, iodide, acetate, propionate, decanoate, caprylate, acrylate, formate, isobutyrate, caprate, heptanoate, propiolate, oxalate, malonate, succinate, suberate, sebacate, fumarate, maleate, butyne-1,4-dioate, hexyne-1,6-dioate, benzoate, chlorobenzoate, methylbenzoate, di nitrobenzoate, hydroxybenzoate, methoxybenzoate, phthalate, terephathalate, sulfonate, xylenesulfonate, phenylacetate, phenylpropionate, phenylbutyrate, citrate, lactate, [beta]-hydroxybutyrate, glycolate, maleate, tartrate, methanesulfonate, propanesulfonate, naphthalene-1-sulfonate, naphthalene-2-sulfonate, mandelate and the like salts. Preferred animal feed acceptable acid addition salts include those formed with mineral acids such as hydrochloric acid and hydrobromic acid, and those formed with organic acids such as maleic acid. Suitable cations for forming feed acceptable salts include ammonium, sodium, potassium, calcium, magnesium and aluminum cations, among others.

As used herein, “essential oil” refers to the set of all the compounds that can be distilled or extracted from a plant from which the oil is derived, or which can be synthetically manufactured, and that contributes to the characteristic aroma of that plant. See e.g., H. McGee, On Food and Cooking, Charles Scribner's Sons, p. 154-157 (1984). Non-limiting examples of essential oils include thymol and cinnamaldehyde

The terms “peptides”, “proteins” and “polypeptides are used interchangeably herein and refer to a polymer of amino acids joined together by peptide bonds. A “protein” or “polypeptide” comprises a polymeric sequence of amino acid residues. The single and 3-letter code for amino acids as defined in conformity with the IUPAC-IUB Joint Commission on Biochemical Nomenclature (JCBN) is used throughout this disclosure. The single letter X refers to any of the twenty amino acids. It is also understood that a polypeptide may be coded for by more than one nucleotide sequence due to the degeneracy of the genetic code.

The terms “derived from” and “obtained from” refer to not only a protein produced or producible by a strain of the organism in question, but also a protein encoded by a DNA sequence isolated from such strain and produced in a host organism containing such DNA sequence. Additionally, the term refers to a protein which is encoded by a DNA sequence of synthetic and/or cDNA origin and which has the identifying characteristics of the protein in question.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number can be a number which, in the context in which it is presented, provides the substantial equivalent of the specifically recited number. For example, in connection with a numerical value, the term “about” refers to a range of −10% to +10% of the numerical value, unless the term is otherwise specifically defined in context.

As used herein, the singular terms “a,” “an,” and “the” include the plural reference unless the context clearly indicates otherwise.

It is further noted that the claims may be drafted to exclude any optional element. As such, this statement is intended to serve as antecedent basis for use of such exclusive terminology as “solely,” “only” and the like in connection with the recitation of claim elements or use of a “negative” limitation.

It is also noted that the phrase “consisting essentially of,” as used herein, refers to a composition wherein the component(s) recited after the phrase is/are in the presence of other known component(s) in a total amount that is less than 30% by weight of the total composition and which do not contribute to or interfere with the actions or activities of the component(s).

It is further noted that the term “comprising,” as used herein, means including, but not limited to, the component(s) after the term “comprising.” The component(s) after the term “comprising” are required or mandatory, but the composition comprising the component(s) can further include other non-mandatory or optional component(s).

It is also noted that the term “consisting of,” as used herein, means including, and limited to, the component(s) after the term “consisting of.” The component(s) after the term “consisting of” are therefore required or mandatory, and no other component(s) are present in the composition.

It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Unless defined otherwise herein, all technical and scientific terms used herein have the same meaning as commonly understood by one of ordinary skill in the art to which this invention pertains.

Other definitions of terms may appear throughout the specification.

### II. Compositions

Provided herein are compositions comprising one or more direct fed microbials (DFMs; for example, a DFM comprising one or more of Bifidobacterium animalis subsp. lactis and/or a Lactobacillus acidophilus) and/or one or more of an osmoregulator (e.g. betaine) and/or one or more essential oils (e.g. cinnamaldehyde and/or thymol) and/or one or more enzymes (e.g. protease, xylanase, beta-glucanase, phytase, and amylase; and/or one or more of aspartic acid (aspartate), ornithine, arginine, phosphate, acetate, and/or a B vitamin (such as vitamin B1, B6, and/or B12).

### A. Direct Fed Microbials (DFMs)

In one embodiment, a DFM can be included in any of the feed additive formulations disclosed herein and, optionally, may be formulated as a liquid, a dry powder or a granule. In one embodiment, the DFMs of any of the feed additive formulations disclosed herein can be formulated as a single mixture. In another embodiment, the DFMs of any of the feed additive formulations disclosed herein can be formulated as separate mixtures. In still another embodiment, separate mixtures of DFMs of any of the feed additive formulations disclosed herein can be administered at the same time or at different times. In still another embodiment, separate mixtures of DFMs of any of the feed additive formulations disclosed herein can be administered simultaneously or sequentially. In yet another embodiment, a first mixture comprising DFMs can be administered followed by a second mixture comprising any of the feed additive formulations disclosed herein. In still another embodiment, a first mixture comprising in any of the feed additive formulations disclosed herein can be administered followed by a second mixture comprising DFMs.

The dry powder or granules may be prepared by means known to those skilled in the art, such as, in top-spray fluid bed coater, in a bottom spray Wurster or by drum granulation (e.g. High sheer granulation), extrusion, pan coating or in a microingredients mixer.

In another embodiment, the one or more osmoregulators (e.g. betaine), essential oils, enzymes, aspartic acid (aspartate), ornithine, arginine, phosphate, acetate, a B vitamin (such as vitamin B1, B6, and/or B12) and/or DFMs may be coated, for example encapsulated. Suitably the osmoregulators (e.g. betaine), essential oils, enzymes, aspartic acid (aspartate), ornithine, arginine, phosphate, acetate, a B vitamin (such as vitamin B1, B6, and/or B12) and/or DFMs may be formulated within the same coating or encapsulated within the same capsule.

In some embodiments, such as where the DFM is capable of producing endospores, the DFM may be provided without any coating. In such circumstances, the DFM endospores may be simply admixed with the osmoregulators (e.g. betaine), essential oils, aspartic acid (aspartate), ornithine, arginine, phosphate, acetate, a B vitamin (such as vitamin B1, B6, and/or B12) and/or enzymes. The osmoregulators (e.g. betaine), essential oils, enzymes, aspartic acid (aspartate), ornithine, arginine, phosphate, acetate, a B vitamin (such as vitamin B1, B6, and/or B12) and/or DFMs may be encapsulated as mixtures (i.e. comprising one or more, two or more, three or more or all) or they may be encapsulated separately, e.g. singly.

At least one DFM may comprise at least one viable microorganism such as a viable bacterial strain or a viable yeast or a viable fungi or a viable mold. In some embodiments, the DFM comprises at least one viable bacterium. It is possible that the DFM may be a spore forming bacterial strain and hence the term DFM may be comprised of or contain spores, e.g. bacterial spores such as endospores. Thus, the term “viable microorganism” as used herein may include microbial spores, such as endospores or conidia. Alternatively, the DFM in the feed additive composition described herein may not comprise of or may not contain microbial spores, e.g. endospores or conidia. The microorganism may be a naturally-occurring microorganism or it may be a transformed microorganism.

A DFM as described herein may comprise microorganisms from one or more of the following genera: Lactobacillus, Lactococcus, Streptococcus, Bacillus, Pediococcus, Enterococcus, Leuconostoc, Carnobacterium, Weissella, Pediococcus Propionibacterium, Bifidobacterium, Clostridium and Megasphaera and combinations thereof. In some embodiments, the DFM comprises one or more bacterial strains selected from Bacillus spp., such as, without limitation, Bacillus subtilis, Bacillus cereus var. toyoi, Bacillus licheniformis, Bacillus pumilis, Bacillus velezensis, and Bacillus amyloliquefaciens.

The genus “Bacillus”, as used herein, includes all species within the genus “Bacillus,” as known to those of skill in the art, including but not limited to B. subtilis, B. licheniformis, B. lentus, B. brevis, B. stearothermophilus, B. alkalophilus, B. amyloliquefaciens, B. clausii, B. halodurans, B. megaterium, B. coagulans, B. circulans, B. gibsonii, B. pumilis and B. thuringiensis. It is recognized that the genus Bacillus continues to undergo taxonomical reorganization. Thus, it is intended that the genus include species that have been reclassified, including but not limited to such organisms as Bacillus stearothermophilus, which is now named “Geobacillus stearothermophilus”, or Bacillus polymyxa, which is now “Paenibacillus polymyxa” The production of resistant endospores under stressful environmental conditions is considered the defining feature of the genus Bacillus, although this characteristic also applies to the recently named Alicyclobacillus, Amphibacillus, Aneurinibacillus, Anoxybacillus, Brevibacillus, Filobacillus, Gracilibacillus, Halobacillus, Paenibacillus, Salibacillus, Thermobacillus, Ureibacillus, and Virgibacillus.

In another aspect, the DFM may be further combined with the following Lactococcus spp: Lactococcus cremoris and Lactococcus lactis and combinations thereof. The DFM can also comprise the following Lactobacillus spp: Lactobacillus buchneri, Lactobacillus acidophilus, Lactobacillus casei, Lactobacillus kefiri, Lactobacillus bifidus, Lactobacillus brevis, Lactobacillus helveticus, Lactobacillus paracasei, Lactobacillus rhamnosus, Lactobacillus salivarius, Lactobacillus curvatus, Lactobacillus bulgaricus, Lactobacillus sakei, Lactobacillus reuteri, Lactobacillus fermentum, Lactobacillus farciminis, Lactobacillus lactis, Lactobacillus delbreuckii, Lactobacillus plantarum, Lactobacillus paraplantarum, Lactobacillus farciminis, Lactobacillus rhamnosus, Lactobacillus crispatus, Lactobacillus gasseri, Lactobacillus johnsonii and Lactobacillus jensenii, and combinations of any thereof. The genus “Lactobacillus”, as used herein, includes all species within the genus “Lactobacillus,” as known to those of skill in the art. It is recognized that the genus Lactobacillus continues to undergo taxonomical reorganization. For example, as of March 2020, Lactobacilli comprised 261 species that are extremely diverse phenotypically, ecologically, and genotypically. Given recent advances in whole genome sequencing and comparative genomics, the genus Lactobacillus was recently divided into 25 separate genera with strains belonging to previously designated Lactobacilli species being transferred to new species and/or genera (see Zheng et al., 2020, Int. J. Syst. Evol. Microbiol., 70:2782-2858; Pot et al., Trends in Food Science & Technology 94 (2019) 105-113; and Koutsoumanis et al., 2020, EFSA Journal, 18(7):6174, the disclosures of each of which are incorporated by reference herein). For purposes of the instant disclosure, the previous classification of Lactobacillus species will continue to be employed. However, in some embodiments Lactobacillus agilis is also classified as as Ligilactobacillus agilis. In other embodiments, Lactobacillus salivarius is also classified as Ligilactobacillus salivarius. In further embodiments, Lactobacillus reuteri is also classified as Limosilactobacillus reuteri.

In still another aspect, the DFM may be further combined with the following Bifidobacteria spp: Bifidobacterium animalis subsp. lactis, Bifidobacterium bifidium, Bifidobacterium longum, Bifidobacterium animalis, Bifidobacterium breve, Bifidobacterium infantis, Bifidobacterium catenulatum, Bifidobacterium pseudocatenulatum, Bifidobacterium adolescentis, and Bifidobacterium angulatum, and combinations of any thereof.

There can be mentioned bacteria of the following species: Bacillus subtilis, Bacillus licheniformis, Bacillus amyloliquefaciens, Bacillus velezensis, Bacillus pumilis, Enterococcus, Enterococcus spp, and Pediococcus spp, Lactobacillus spp, Bifidobacterium spp, Lactobacillus acidophilus, Pediococsus acidilactici, Lactococcus lactis, Bifidobacterium bifidum, Bacillus subtilis, Propionibacterium thoenii, Lactobacillus farciminis, Lactobacillus rhamnosus, Megasphaera elsdenii, Clostridium butyricum, Clostridium tyrobutyricum, Bifidobacterium animalis ssp. animalis, Lactobacillus reuteri, Bacillus cereus, Lactobacillus salivarius ssp. salivarius, Propionibacteria spp and combinations thereof.

A direct-fed microbial described herein comprising one or more bacterial strains may be of the same type (genus, species and strain) or may comprise a mixture of genera, species and/or strains. Alternatively, a DFM may be combined with one or more of the products or the microorganisms contained in those products disclosed in WO2012110778 and summarized as follows: Bacillus subtilis strain 2084 Accession No. NRRLB-50013, Bacillus subtilis strain LSSAO1 Accession No. NRRL B-50104, and Bacillus subtilis strain 15A-P4 ATCC Accession No. PTA-6507 (from Enviva Pro®. (formerly known as Avicorr®); Bacillus subtilis Strain C3102 (from Calsporin®); Bacillus subtilis Strain PB6 (from Clostat®); Bacillus pumilis (8G-134); Enterococcus NCIMB 10415 (SF68) (from Cylactin®); Bacillus subtilis Strain C3102 (from Gallipro® & GalliproMax®); Bacillus licheniformis (from Gallipro®Tect®); Enterococcus and Pediococcus (from Poultry Star®); Lactobacillus, Bifidobacterium and/or Enterococcus from Protexin®); Bacillus subtilis strain QST 713 (from Proflora®); Bacillus amyloliquefaciens CECT-5940 (from Ecobiol® & Ecobiol® Plus); Enterococcus faecium SF68 (from Fortiflora®); Bacillus subtilis and Bacillus licheniformis (from BioPlus2B®); Lactic acid bacteria 7 Enterococcus faecium (from Lactiferm®); Bacillus subtilis strain QST 713 from Baymix® Grobig BS; Lactobacillus strains from LACTILLUS™; Bacillus strain (from CSI®); Saccharomyces cerevisiae (from Yea-Sacc®); Bacillus subtilis (Bacillus velezensis NRRL B-67259) from Correlink™), Enterococcus (from Biomin IMB52®); Pediococcus acidilactici, Enterococcus, Bifidobacterium animalis ssp. animalis, Lactobacillus reuteri, Lactobacillus salivarius ssp. salivarius (from Biomin C5®); Lactobacillus farciminis (from Biacton®); Enterococcus (from Oralin E1707®); Enterococcus (2 strains), Lactococcus lactis DSM 1103 (from Probios-pioneer PDFM®); Lactobacillus rhamnosus and Lactobacillus farciminis (from Sorbiflore®); Bacillus subtilis (from Animavit®); Enterococcus (from Bonvital®); Saccharomyces cerevisiae (from Levucell SB 20@); Saccharomyces cerevisiae (from Levucell SC 0 & SC10® ME); Pediococcus acidilacti (from Bactocell); Saccharomyces cerevisiae (from ActiSaf® (formerly BioSaf®)); Saccharomyces cerevisiae NCYC Sc47 (from Actisaf® SC47); Clostridium butyricum (from Miya-Gold®); Enterococcus (from Fecinor and Fecinor Plus®); Saccharomyces cerevisiae NCYC R-625 (from InteSwine@); Saccharomyces cerevisia (from BioSprint®); Enterococcus and Lactobacillus rhamnosus (from Provita®); Bacillus subtilis and Aspergillus oryzae (from PepSoyGen-C®); Bacillus cereus (from Toyocerin®); Bacillus cereus var. toyoi NCIMB 40112/CNCM I-1012 (from TOYOCERIN®), or other DFMs such as Bacillus licheniformis and Bacillus subtilis (from BioPlus® YC) and Bacillus subtilis (from GalliPro®).

The DFM may be combined with Enviva® PRO which is commercially available from Danisco A/S. Enviva® PRO is a combination of Bacillus strain 2084 Accession No. NRRL B-50013, Bacillus strain LSSAO1 Accession No. NRRL B-50104 and Bacillus strain 15A-P4 ATCC Accession No. PTA-6507 (as taught in U.S. Pat. No. 7,754,469 B—incorporated herein by reference). Preferably, the DFM described herein comprises microorganisms which are generally recognized as safe (GRAS) and, preferably are GRAS-approved. A person of ordinary skill in the art will readily be aware of specific species and/or strains of microorganisms from within the genera described herein which are used in the food and/or agricultural industries and which are generally considered suitable for animal consumption.

In another embodiment, the DFM can be combined with one or more of L. reuteri strain S1, L. reuteri strain S2, L. reuteri strain S3, L. reuteri strain A2, L. gallinarum strain H1, L. salivarius strain H2, and/or L. agilis strain H3 which were deposited on Jul. 24, 2019 at the Westerdijk Fungal Biodiversity Institute (WFDB), Uppsalalaan 8, 3584 CT, Utrecht, The Netherlands and given accession numbers CBS 145921, CBS 145922, CBS 145923, CBS 145924, CBS145918, CBS145919, and CBS 145920, respectively. The deposits were made under the provisions of the Budapest Treaty on the International Recognition of the Deposit of Microorganisms for the Purposes of Patent Procedure (see also International Patent Application Publication No. WO2021034660, incorporated by reference herein in its entirety).

In some embodiments, it is important that the DFM be heat tolerant, i.e. is thermotolerant. This is particularly the case when the feed is pelleted. Therefore, in another embodiment, the DFM may be a thermotolerant microorganism, such as a thermotolerant bacteria, including for example Bacillus spp.

In other aspects, it may be desirable that the DFM comprises a spore producing bacteria, such as Bacillus, e.g. Bacillus spp. Bacillus are able to form stable endospores when conditions for growth are unfavorable and are very resistant to heat, pH, moisture and disinfectants.

The DFM described herein may decrease or prevent intestinal establishment of pathogenic microorganism (such as Clostridium perfringens and/or E. coli and/or Salmonella spp and/or Campylobacter spp.). In other words, the DFM may be antipathogenic. The term “antipathogenic” as used herein means the DFM counters an effect (negative effect) of a pathogen.

As described above, the DFM may be any suitable DFM. For example, the following assay “DFM ASSAY” may be used to determine the suitability of a microorganism to be a DFM. The DFM assay as used herein is explained in more detail in US2009/0280090. For avoidance of doubt, the DFM selected as an inhibitory strain (or an antipathogenic DFM) in accordance with the “DFM ASSAY” taught herein is a suitable DFM for use in accordance with the present disclosure, i.e. in the feed additive composition according to the present disclosure. Tubes were seeded each with a representative pathogen (e.g., bacteria) from a representative cluster. Supernatant from a potential DFM, grown aerobically or anaerobically, is added to the seeded tubes (except for the control to which no supernatant is added) and incubated. After incubation, the optical density (OD) of the control and supernatant treated tubes was measured for each pathogen. Colonies of (potential DFM) strains that produced a lowered OD compared with the control (which did not contain any supernatant) can then be classified as an inhibitory strain (or an antipathogenic DFM). Thus, The DFM assay as used herein is explained in more detail in US2009/0280090. In some embodiments, a representative pathogen used in this DFM assay can be one (or more) of the following: Clostridium, such as Clostridium perfringens and/or Clostridium difficile, and/or E. coli and/or Salmonella spp and/or Campylobacter spp. In one preferred embodiment, the assay is conducted with one or more of Clostridium perfringens and/or Clostridium difficile and/or E. coli, preferably Clostridium perfringens and/or Clostridium difficile, more preferably Clostridium perfringens.

DFMs may be prepared as culture(s) and carrier(s) (where used) and can be added to a ribbon or paddle mixer and mixed for about 15 minutes, although the timing can be increased or decreased. The components are blended such that a uniform mixture of the cultures and carriers result. The final product is preferably a dry, flowable powder. The DFM(s) comprising one or more bacterial strains can then be added to animal feed or a feed premix, added to an animal's water, or administered in other ways known in the art (preferably simultaneously with the enzymes described herein. Inclusion of the individual strains in the DFM mixture can be in proportions varying from 1% to 99% and, preferably, from 25% to 75% Suitable dosages of the DFM in animal feed may range from about 1×10³ CFU/g feed to about 1×10¹⁰ CFU/g feed, suitably between about 1×10⁴ CFU/g feed to about 1×10⁸ CFU/g feed, suitably between about 7.5×10⁴ CFU/g feed to about 1×10⁷ CFU/g feed. In another aspect, the DFM may be dosed in feedstuff at more than about 1×10³ CFU/g feed, suitably more than about 1×10⁴ CFU/g feed, suitably more than about 5×10⁴ CFU/g feed, or suitably more than about 1×10⁵ CFU/g feed.

The DFM may be dosed in a feed additive composition from about 1×10³ CFU/g composition to about 1×10¹³ CFU/g composition, such as 1×10⁵ CFU/g composition to about 1×10¹³ CFU/g composition, such as between about 1×10⁶ CFU/g composition to about 1×10¹² CFU/g composition, and such as between about 3.75×10⁷ CFU/g composition to about 1×10¹¹ CFU/g composition. In another aspect, the DFM may be dosed in a feed additive composition at more than about 1×10⁵ CFU/g composition, such as more than about 1×10⁶ CFU/g composition, and such as more than about 3.75×10⁷ CFU/g composition. In one embodiment, the DFM is dosed in the feed additive composition at more than about 2×10⁵ CFU/g composition, such as more than about 2×10⁶ CFU/g composition, suitably more than about 3.75×10⁷ CFU/g composition.

In some embodiments, the DFMs are Bifidobacterium animalis subsp. lactis strain B1-04 and/or Lactobacillus acidophilus strain NCFM. These bacterial strains were deposited by DuPont Nutrition Biosciences ApS, of Langebrogade 1, DK-1411 Copenhagen K, Denmark, in accordance with the Budapest Treaty at the Leibniz-Institut Deutsche Sammlung von Mikroorganismen und Zellkulturen GmbH (DSMZ), Inhoffenstrasse 7B, 38124 Braunschweig, Germany, where they are recorded under the following registration numbers: Strain NCFM (DSM33840); deposited on 15 Mar. 2021 and Strain B1-04 (DSM33525); deposited on 19 May 2020. These bacterial strains are commercially available from DuPont Nutrition Biosciences ApS.

Additionally, in some embodiments, the secretomes or fractions thereof of any of the DFMs disclosed herein (such as the secretomes of Bifidobacterium animalis subsp. lactis strain B1-04 and/or Lactobacillus acidophilus strain NCFM) can be used in any of the compositions or methods disclosed herein. Secretomes for any of the DFMs disclosed herein can be obtained through any standard means known in the art and include, without limitation, cultured cell supernatants, modified supernatants, supernatant fractions, partially purified secretomes, and secretome fractions of cells.

### B. Essential Oils

Essential oils are concentrated volatile oils having the characteristic odor of the plant from which they are derived. Typically, essential oils are obtained by distillation of the plant and comprise a mixture of component compounds. These component compounds of essential oils include anethole, beta-ionone, capsaicin, carvacrol, cinnamaldehyde, citral, cresols, eugenol, guaiacol, limonene, thymol, tannin and vanillin.

The animal feed or feed additive compositions disclosed herein may comprise at least 1 g of cinnamaldehyde per 1000 kg of animal feed, at least 2 g of cinnamaldehyde per 1000 kg of animal feed, at least 3 g of cinnamaldehyde per 1000 kg of animal feed, at least 4 g of cinnamaldehyde per 1000 kg of animal feed, at least 5 g of cinnamaldehyde per 1000 kg of animal feed.

The animal feed or feed additive compositions disclosed herein may comprise at least 1 mg of cinnamaldehyde per kg of animal feed, at least 2 mg of cinnamaldehyde per kg of animal feed, at least 3 mg of cinnamaldehyde per kg of animal feed, at least 4 mg of cinnamaldehyde per kg of animal feed, at least 5 mg of cinnamaldehyde per kg of animal feed.

For broilers, the animal feed or feed additive compositions disclosed herein may comprise less than 6 g of cinnamaldehyde per 1000 kg of the animal feed; such as, e.g., less than 5.9 g of cinnamaldehyde. For pigs, the animal feed may comprise less than 18 g of cinnamaldehyde per 1000 kg of animal feed, such as, e.g. less than 17 g of cinnamaldehyde per 1000 kg of animal feed, less than 16 g of cinnamaldehyde per 1000 kg of animal feed, less than 15 g of cinnamaldehyde per 1000 kg of animal feed, less than 14 g of cinnamaldehyde per 1000 kg of animal feed.

Where the animal feed or feed additive compositions disclosed herein includes thymol, the animal feed may comprise at least 1 g of thymol per 1000 kg of animal feed or feed additive compositions, at least 2 g of thymol per 1000 kg of animal feed or feed additive compositions, at least 3 g of thymol per 1000 kg of animal feed or feed additive compositions, at least 4 g of thymol per 1000 kg of animal feed or feed additive compositions, at least 5 g of thymol per 1000 kg of animal feed or feed additive compositions, at least 6 g of thymol per 1000 kg of animal feed or feed additive compositions, at least 7 g of thymol per 1000 kg of animal feed or feed additive compositions, at least 8 g of thymol per 1000 kg of animal feed or feed additive compositions, at least 9 g of thymol per 1000 kg of animal feed or feed additive compositions, at least 10 g of thymol per 1000 kg of animal feed or feed additive compositions, at least 11 g of thymol per 1000 kg of animal feed or feed additive compositions, at least 12 g of thymol per 1000 kg of animal feed or feed additive compositions, at least 13 g of thymol per 1000 kg of animal feed or feed additive compositions, at least 14 g of thymol per 1000 kg of animal feed or feed additive compositions, at least 15 g of thymol per 1000 kg of animal feed or feed additive compositions. The animal feed or feed additive compositions may comprise less than 50 g of thymol per 1000 kg of animal feed or feed additive compositions.

The animal feed or feed additive compositions disclosed herein may comprise at least 0.00001% by weight of components (i), (ii) and carvacol. Suitably, the animal feed or feed additive compositions may comprise at least 0.00005%; at least 0.00010%; at least 0.00020%; at least 0.00025%; at least 0.00050%; at least 0.00100%; at least 0.00200% by weight of components (i), (ii) and carvacol.

The animal feed or feed additive compositions disclosed herein may comprise at least 0.0001% by weight of the feed enzymes. Suitably, the animal feed may comprise at least 0.0005%; at least 0.0010%; at least 0.0020%; at least 0.0025%; at least 0.0050%; at least 0.0100% by weight of the feed enzyme. The animal feed may comprise at least 0.001% by weight of the animal feed additive. Suitably, the animal feed may comprise at least 0.005%; at least 0.010%; at least 0.020%; at least 0.100%; at least 0.200%; at least 0.250%; at least 0.500% by weight of the animal feed additive or feed additive compositions.

### C. Enzymes

In one embodiment, the disclosure relates osmoregulator (e.g. betaine), essential oil, aspartic acid (aspartate), ornithine, arginine, phosphate, acetate, a B vitamin (such as vitamin B1, B6, and/or B12) and/or DFM-containing feed or feed additive compositions further containing at least one enzyme (e.g. a phytase). Suitable enzymes for use in accordance with the methods disclosed herein include, without limitation, glucoamylases, xylanases, amylases, phytases, beta-glucanases, and proteases.

### 1. Glucoamylases

Glucoamylase (1,4-alpha-D-glucan glucohydrolase, EC 3.2.1.3) is an enzyme, which catalyzes the release of D-glucose from the non-reducing ends of starch or related oligo- and poly-saccharide molecules. Glucoamylases are produced by several filamentous fungi and yeast.

In one embodiment, provided herein are osmoregulator (e.g. betaine), essential oil, and/or DFM feed or feed additive compositions including one or more glucoamylase. The glucoamylase may be any commercially available glucoamylase. Suitably the glucoamylase may be an 1,4-alpha-D-glucan glucohydrolase (EC 3.2.1.3). All E.C. enzyme classifications referred to herein relate to the classifications provided in Enzyme Nomenclature—Recommendations (1992) of the nomenclature committee of the International Union of Biochemistry and Molecular Biology—ISBN 0-12-226164-3, which is incorporated herein.

Glucoamylases have been used successfully in commercial applications for many years. Additionally, various mutations have been introduced in fungal glucoamylases, for example, Trichoderma reesei glucoamylase (TrGA), to enhance thermal stability and specific activity. See, e.g., WO 2008/045489; WO 2009/048487; WO 2009/048488; and U.S. Pat. No. 8,058,033. Glucoamylase activity can be assessed using any means known in the art, including those described in the Examples section, infra.

A glucoamylase may be derived from any suitable source, e.g., derived from a microorganism or a plant. Glucoamylases can be from fungal or bacterial origin, selected from the group consisting of Aspergillus glucoamylases, in for example, Aspergillus niger G1 or G2 glucoamylase (Boel et al., 1984, EMBO J. 3(5): 1097-1102), or variants thereof, such as those disclosed in WO 92/00381, WO 00/04136 and WO 01/04273 (from Novozymes, Denmark); the A. awamori glucoamylase disclosed in WO 84/02921, Aspergillus oryzae glucoamylase (Hata et al., 1991, Agric. Biol. Chem. 55(4): 941-949), or variants or fragments thereof. Other Aspergillus glucoamylase variants include variants with enhanced thermal stability: G137A and G139A (Chen et al., 1996, Prot. Eng. 9: 499-505); D257E and D293E/Q (Chen et al., 1995, Prot. Eng. 8: 575-582); N182 (Chen et al., 1994, Biochem. J. 301: 275-281); disulphide bonds, A246C (Fierobe et al., 1996, Biochemistry 35: 8698-8704; and introduction of Pro residues in positions A435 and S436 (Li et al., 1997, Protein Eng. 10: 1199-1204.

Other glucoamylases include Athelia rolfsii (previously denoted Corticium rolfsi) glucoamylase (see U.S. Pat. No. 4,727,026 and Nagasaka et al., 1998, Appl. Microbiol. Biotechnol. 50: 323-330), Talaromyces glucoamylases, in particular derived from Talaromyces duponti, Talaromyces emersonii (WO 99/28448), Talaromyces leycettanus (U.S. Pat. No. Re. 32,153), and Talaromyces thermophilus (U.S. Pat. No. 4,587,215).

Bacterial glucoamylases include glucoamylases from Clostridium, in particular C. thermoamylolyticum (EP 135138) and C. thermohydrosulfuricum (WO86/01831), Trametes cingulata, Pachykytospora papyracea, and Leucopaxillus giganteus, all disclosed in WO 2006/069289; or Peniophora rufomarginata disclosed in WO2007/124285 or PCT/US2007/066618; or a mixture thereof. A hybrid glucoamylase may be used in the present invention. Examples of hybrid glucoamylases are disclosed in WO 2005/045018. Specific examples include the hybrid glucoamylase disclosed in Tables 1 and 4 of Example 1 (which hybrids are hereby incorporated by reference).

The glucoamylase may have a high degree of sequence identity to any of above mentioned glucoamylases, i.e., at least 70%, at least 75%, at least 80%, at least 85%, at least 90%, at least 95%, at least 96%, at least 97%, at least 98%, at least 99% or even 100% identity to the mature enzymes sequences mentioned above.

Commercially available glucoamylase compositions include AMG 200L; AMG 300L; SAN™ SUPER, SAN™ EXTRA L, SPIRIZYME™ PLUS, SPIRIZYME™ FUEL, SPIRIZYME™ B4U, SPIRIZYME ULTRA, SPIRIZYME™ EXCEL and AMG™ E (from Novozymes A/S, Denmark); OPTIDEX™ 300, GC480™ and GC147™ (from Genencor Int., USA); AMIGASE™ and AMIGASE™ PLUS (from DSM); G-ZYME™ G900, G-ZYME™ and G990 ZR (from Genencor Int.).

### 2. Xylanases

Xylanase is the name given to a class of enzymes that degrade the linear polysaccharide β-1,4-xylan into xylose, thus breaking down hemicellulose, one of the major components of plant cell walls. Xylanases, e.g., endo-β-xylanases (EC 3.2.1.8) hydrolyze the xylan backbone chain. In one embodiment, provided herein are osmoregulator (e.g. betaine), essential oil, and/or DFM-containing feed or feed additive compositions comprising and one or more xylanase.

In another embodiment, provided herein are feed or feed additive compositions including one or more xylanase. In one embodiment, the xylanase may be any commercially available xylanase. Suitably the xylanase may be an endo-1,4-P-d-xylanase (classified as E.G. 3.2.1.8) or a 1,4β-xylosidase (classified as E.G. 3.2.1.37). All E.C. enzyme classifications referred to herein relate to the classifications provided in Enzyme Nomenclature—Recommendations (1992) of the nomenclature committee of the International Union of Biochemistry and Molecular Biology—ISBN 0-12-226164-3, which is incorporated herein

In another embodiment, the xylanase may be a xylanase from Bacillus, Trichodermna, Therinomyces, Aspergillus and Penicillium. In still another embodiment, the xylanase may be the xylanase in Axtra XAP® or Avizyme 1502®, both commercially available products from Danisco A/S. In one embodiment, the xylanase may be a mixture of two or more xylanases. In still another embodiment, the xylanase is an endo-1,4-O-xylanase or a 1,4-O-xylosidase. In yet another embodiment, the xylanase is from an organism selected from the group consisting of: Bacillus, Trichoderma, Thermomyces, Aspergillus, Penicillium, and Humicola. In yet another embodiment, the xylanase may be one or more of the xylanases or one or more of the commercial products recited in Table 1.

TABLE 1
Representative commercial xylanases

| Commercial | | | |
|---|---|---|---|
| Name ® | Company | xylanase type | xylanase source |
| Alizyme PT | A [symbol] ech | endo-1,4-β-xylanases | Aspergillus Niger |
| Amylofeed | Andres Pintaluba | endo-1,4-β-xylanases | Aspergillus Niger (phoe [symbol] s) |
| | S.A | | |
| Avemix 02 C [symbol] | Aveve | endo-1,4-β-xylanases | Trichoderma ressei |
| Avemix XG 10 | Aveve, NL | endo-1,4-β-xylanases | Trichoderma ressei |
| Avizyme 1100 | Danisco | endo-1,4-β-xylanases | Trichoderma longbrachiatum |
| Avizyme 1110 | Danisco | endo-1,4-β-xylanases | Trichoderma longbrachiatum |
| Avizyme 1202 | Danisco | endo-1,4-β-xylanases | Trichoderma longbrachiatum |
| Avizyme 1210 | Danisco | endo-1,4-β-xylanases | Trichoderma longbrachiatum |
| Avizyme 1302 | Danisco | endo-1,4-β-xylanases | Trichoderma longbrachiatum |
| Avizyme 1500 | Danisco | endo-1,4-β-xylanases | Trichoderma longbrachiatum |
| Avizyme 1505 | Danisco | endo-1,4-β-xylanases | Trichoderma longbrachiatum |
| Avizyme SX | Danisco | endo-1,4-β-xylanases | Trichoderma longbrachiatum |
| B [symbol] feed MP 100 | Be [symbol] em | endo-1,4-β-xylanases | Bacillus subtilis |
| Biofeed Plus | DSM | endo-1,4-β-xylanases | Humicola insolens |
| Danisco | Danisco Animal | endo-1,4-β-xylanases | Trichoderma ressei |
| Glycosidase | Nutrition | | |
| (TPT/L) | | | |
| Danisco | Danisco | endo-1,4-β-xylanases | Trichoderma ressei |
| Xylanase | | | |
| Econase XT | AB Vista | endo-1,4-β-xylanases | Trichoderma ressei |
| Endofeed [symbol] DC | Andres Pintaluba | endo-1,4-β-xylanases | Aspergillus Niger |
| | S.A. | | |
| Feedlyve AXL | Lyv [symbol] n | endo-1,4-β-xylanases | Trichoderma longbrachiatum |
| Grindazym GP | Danisco | endo-1,4-β-xylanases | Aspergillus Niger |
| Grindazym GV | Danisco | endo-1,4-β-xylanases | Aspergillus Niger |
| Hostazym X | H [symbol] pha [symbol] a | endo-1,4-β-xylanases | Trichoderma longbrachiatum |
| Kemzyme Plus | kemin | endo-1,4-β-xylanases | Trichoderma Viride |
| Dry | | | |
| Kemzyme Plus | kemin | endo-1,4-β-xylanases | Trichoderma Viride |
| liquid | | | |
| Kemzyme W dry | kemin | endo-1,4-β-xylanases | Trichoderma Viride |
| Kemzyme W | kemin | endo-1,4-β-xylanases | Trichoderma Viride |
| liquid | | | |
| Natugrain | BASF | endo-1,4-β-xylanases | Trichoderma longbrachiatum |
| Natugrain TS Plus | BASF | endo-1,4-β-xylanases | Aspergillus Niger |
| Natugrain Wheat | BASF | endo-1,4-β-xylanases | Aspergillus Niger |
| Natugrain [symbol] TS/L | BASF | endo-1,4-β-xylanases | Aspergillus Niger |
| Natuzyme | B [symbol] oproton | endo-1,4-β-xylanases | Trichoderma longbrachiatum/ |
| | | | Trichoderma ressei |
| Porzyme 8100 | Danisco | endo-1,4-β-xylanases | Trichoderma longbrachiatum |
| Porzyme 8300 | Danisco | endo-1,4-β-xylanases | Trichoderma longbrachiatum |
| Porzyme 9102 | Danisco | endo-1,4-β-xylanases | Trichoderma longbrachiatum |
| Porzyme | Danisco | endo-1,4-β-xylanases | Trichoderma longbrachiatum |
| 9310/Avizyme | | | |
| 1310 | | | |
| Porzyme tp 100 | Danisco | endo-1,4-β-xylanases | Trichoderma longbrachiatum |
| Ronozyme AX | DSM | endo-1,4-β-xylanases | Thermomyces lanuginosus |
| | | | gene |
| | | | expressed in Aspergillus oryzae |
| Ronozyme WX | DSM/Novozymes | endo-1,4-β-xylanases | Thermomyces lanuginosus |
| | | | gene |
| | | | expressed in Aspergillus oryzae |
| Rovable Excel | Ad [symbol] o | endo-1,4-β-xylanases | Penicillium funiculosum |
| Roxazyme G2 | DSM/Novozymes | endo-1,4-β-xylanases | Trichoderma longbrachiatum |
| Sa [symbol] zym X | Le Saffre | endo-1,4-β-xylanases | Trichoderma longbrachiatum |
| Xylanase | Lyvan | endo-1,4-β-xylanases | Trichoderma longbrachiatum |

[symbol]

indicates data missing or illegible when filed

In one embodiment, the disclosure relates to a feed or feed additive composition comprising one or more xylanase. In one embodiment, the composition comprises 10-50, 50-100, 100-150, 150-200, 200-250, 250-300, 300-350, 350-400, 400-450, 450-500, 500-550, 550-600, 600-650, 650-700, 700-750, and greater than 750 xylanase units/g of composition.

In one embodiment, the composition comprises 500-1000, 1000-1500, 1500-2000, 2000-2500, 2500-3000, 3000-3500, 3500-4000, 4000-4500, 4500-5000, 5000-5500, 5500-6000, 6000-6500, 6500-7000, 7000-7500, 7500-8000, and greater than 8000 xylanase units/g composition.

It will be understood that one xylanase unit (XU) is the amount of enzyme that releases 0.5 mol of reducing sugar equivalents (as xylose by the Dinitrosalicylic acid (DNS) assay-reducing sugar method) from an oat-spelt-xylan substrate per min at pH 5.3 and 50° C. (Bailey, et al., Journal of Biotechnology, Volume 23, (3), May 1992, 257-270).

### 3. Amylases

Amylase is a class of enzymes capable of hydrolysing starch to shorter-chain oligosaccharides, such as maltose. The glucose moiety can then be more easily transferred from maltose to a monoglyceride or glycosylmonoglyceride than from the original starch molecule. The term amylase includes α-amylases (E.G. 3.2.1.1), G4-forming amylases (E.G. 3.2.1.60), 3-amylases (E.G. 3.2.1.2) and 7-amylases (E.C. 3.2.1.3). Amylases may be of bacterial or fungal origin, or chemically modified or protein engineered mutants. In another embodiment, provided herein are osmoregulator (e.g. betaine), essential oil, and/or DFM-containing feed or feed additive compositions including one or more amylase.

In one embodiment, the amylase may be a mixture of two or more amylases. In another embodiment, the amylase may be an amylase, e.g. an α-amylase, from Bacillus licheniformis and an amylase, e.g. an α-amylase, from Bacillus amyloliquefaciens. In one embodiment, the α-amylase may be the α-amylase in Axtra XAP® or Avizyme 1502®, both commercially available products from Danisco A/S. In yet another embodiment, the amylase may be a pepsin resistant α-amylase, such as a pepsin resistant Trichoderma (such as Trichoderma reesei) alpha amylase. A suitably pepsin resistant α-amylase is taught in UK application number 101 1513.7 (which is incorporated herein by reference) and PCT/IB2011/053018 (which is incorporated herein by reference).

In one embodiment, the amylase for use in the present invention may be one or more of the amylases in one or more of the commercial products recited in Table 2.

TABLE 2
Representative commercial amylases

| Commercial | | | |
|---|---|---|---|
| Product ® | Company | Amylase type | Amylase source |
| Amylofeed | Andres | alpha amylase | Aspergillus oryzae |
| | Pintaluba S.A | | |
| Avlzyme 1500 | Danisco | alpha amylase | Bac [symbol] llus |
| | | | amylol [symbol] quefaciens |
| Avlzyme 1505 | Danisco | alpha amylase | Bac [symbol] llus |
| | | | amylol [symbol] quefaciens |
| Kemzyme Plus | Kemin | alpha-amylase | Bac [symbol] llus |
| Dry | | | amylol [symbol] quefaclens |
| Kemzyme Plus | Kemin | alpha-amylase | Bac [symbol] llus |
| Liquid | | | amylol [symbol] quefaciens |
| Kemzyme W dry | Kem [symbol] n | alpha-amylase | Bacillus |
| | | | amyloliquefaciens |
| Kemzyme W | Kem [symbol] n | alpha-amylase | Bacillos |
| Liquid | | | amyloliquefaciens |
| Natuzyme | B [symbol] oproton | alpha-amylase | Trichoderma |
| | | | longbrachiatum/ |
| | | | Trichoderma ressei |
| Porzyme 8100 | Dan [symbol] sco | alpha-amylase | Bacillus |
| | | | amyloliquefaciens |
| Porzyme tp100 | Danisco | alpha-amylase | Bacillus |
| | | | amyloliquefaciens |
| Ronozyme A | DSM/ | alpha-amylase | Bac [symbol] llus |
| | Novozymes | | amylol [symbol] quefaciens |
| Ronozyme AX | DSM | alpha-amylase | Bacillus |
| | | | amyloliquefaciens |
| Ronozyme [symbol] | DSM/ | alpha-amylase | Bac [symbol] llus |
| RumlStar (L/CT) | Novozymes | | stearothermoph [symbol] lus |
| | | | expressed in |
| | | | Bacillus |
| | | | licheniformis |

[symbol]

indicates data missing or illegible when filed

will be understood that one amylase unit (AU) is the amount of enzyme that releases 1 mmol of glucosidic linkages from a water insoluble cross-linked starch polymer substrate per min at pH 6.5 and 37° C. (this may be referred to herein as the assay for determining 1 AU).

In one embodiment, the disclosure relates to a feed or feed additive composition comprising one or more amylase. In one embodiment, the composition comprises 10-50, 50-100, 100-150, 150-200, 200-250, 250-300, 300-350, 350-400, 400-450, 450-500, 500-550, 550-600, 600-650, 650-700, 700-750, and greater than 750 amylase units/g composition.

In one embodiment, the composition comprises 500-1000, 1000-1500, 1500-2000, 2000-2500, 2500-3000, 3000-3500, 3500-4000, 4000-4500, 4500-5000, 5000-5500, 5500-6000, 6000-6500, 6500-7000, 7000-7500, 7500-8000, 8000-8500, 8500-9000, 9000-9500, 9500-10000, 10000-11000, 11000-12000, 12000-13000, 13000-14000, 14000-15000 and greater than 15000 amylase units/g composition.

### 4. Proteases

The term protease as used herein is synonymous with peptidase or proteinase. The protease may be a subtilisin (E.G. 3.4.21.62) or a bacillolysin (E.G. 3.4.24.28) or an alkaline serine protease (E.G. 3.4.21.x) or a keratinase (E.G. 3.4.X.X). In one embodiment, the protease is a subtilisin. Suitable proteases include those of animal, vegetable or microbial origin. Chemically modified or protein engineered mutants are also suitable. The protease may be a serine protease or a metalloprotease. e.g., an alkaline microbial protease or a trypsin-like protease. In another embodiment, provided herein are osmoregulator (e.g. betaine), essential oil, and/or DFM-containing feed or feed additive compositions including one or more protease.

Examples of alkaline proteases are subtilisins, especially those derived from Bacillus sp., e.g., subtilisin Novo, subtilisin Carlsberg, subtilisin 309 (see, e.g., U.S. Pat. No. 6,287,841), subtilisin 147, and subtilisin 168 (see, e.g., WO 89/06279). Examples of trypsin-like proteases are trypsin (e.g., of porcine or bovine origin), and Fusarium proteases (see, e.g., WO 89/06270 and WO 94/25583). Examples of useful proteases also include but are not limited to the variants described in WO 92/19729 and WO 98/20115.

In another embodiment, the protease may be one or more of the proteases in one or more of the commercial products recited in Table 3.

TABLE 3
Representative commercial proteases
Representative examples of commercial proteases

| Commercial | | Protease | |
|---|---|---|---|
| Product [symbol] | Company | type | Protease source |
| Avizyme 1100 | Danisco A/S | Subtilisin | Bac [symbol] llus subt [symbol] lls |
| Avizyme 1202 | Danisco A/S | Subtilisin | Bac [symbol] llus subt [symbol] lls |
| Avizyme 1302 | Danisco A/S | Subtilisin | Bac [symbol] llus subt [symbol] lls |
| Avizyme 1500 | Dan [symbol] sco A/S | Subt [symbol] l [symbol] s [symbol] n | Bac [symbol] llus subt [symbol] lls |
| Avizyme 1505 | Dan [symbol] sco A/S | Subt [symbol] l [symbol] s [symbol] n | Bac [symbol] llus subt [symbol] lls |
| Kemzyme Plus | Kem [symbol] n | Bacillolysin | Bacillus |
| Dry | | | amyloliquefaciens |
| Kemzyme W Dry | Kem [symbol] n | Bacillolysin | Bacillus |
| | | | amyloliquefaciens |
| Natuzyme | Bioproton | Protease | Trichoderma |
| | | | longibrachiatum/ |
| | | | Trichoderma |
| | | | ressei |
| Porzyme 8300 | Dan [symbol] sco | Subt [symbol] l [symbol] sin | Bac [symbol] llus subt [symbol] l [symbol] s |
| Ronozyme | DSM/Novozymes | Alkal [symbol] ne | Nocardlops [symbol] s |
| ProAct | | Serine | pras [symbol] na |
| | | protease | gene expressed In |
| | | | Bac [symbol] llus |
| | | | licheniformis |
| Versazyme/Cibenza | Novus | Kerat [symbol] nase | Bac [symbol] llus |
| DP100 | | | [symbol] chen [symbol] form [symbol] s |

[symbol]

indicates data missing or illegible when filed

In one embodiment, the protease is selected from the group consisting of subtilisin, a bacillolysin, an alkine serine protease, a keratinase, and a Nocardiopsis protease.

It will be understood that one protease unit (PU) is the amount of enzyme that liberates from the substrate (0.6% casein solution) one microgram of phenolic compound (expressed as tyrosine equivalents) in one minute at pH 7.5 (40 mM Na₂PO₄/lactic acid buffer) and 40° C. This may be referred to as the assay for determining 1 PU.

In one embodiment, the disclosure relates to a feed or feed additive composition comprising one or more protease. In another embodiment, the disclosure relates to a feed or feed additive composition comprising one or more xylanase and protease. In still another embodiment, the disclosure relates to a feed or feed additive composition comprising one or more amylase and protease. In yet another embodiment, the disclosure relates to a feed or feed additive composition comprising one or more xylanase, amylase and protease.

In one embodiment, the composition comprises 10-50, 50-100, 100-150, 150-200, 200-250, 250-300, 300-350, 350-400, 400-450, 450-500, 500-550, 550-600, 600-650, 650-700, 700-750, and greater than 750 protease units/g composition.

In one embodiment, the composition comprises 500-1000, 1000-1500, 1500-2000, 2000-2500, 2500-3000, 3000-3500, 3500-4000, 4000-4500, 4500-5000, 5000-5500, 5500-6000, 6000-6500, 6500-7000, 7000-7500, 7500-8000, 8000-8500, 8500-9000, 9000-9500, 9500-10000, 10000-11000, 11000-12000, 12000-13000, 13000-14000, 14000-15000 and greater than 15000 protease units/g composition.

### 5. Phytases

In another embodiment, provided herein are osmoregulator (e.g. betaine), essential oil, and/or DFM-containing feed or feed additive compositions including one or more phytase. The phytase for use in the present invention may be classified a 6-phytase (classified as E.C. 3.1.3.26) or a 3-phytase (classified as E.C. 3.1.3.8). In one embodiment, the phytase for use in the present invention may be one or more of the phytases in one or more of the commercial products below in Table 4:

TABLE 4
Representative commercial phytases

| Commercial | | | |
|---|---|---|---|
| Product [symbol] | Company | Phytase type | Phytase source |
| [symbol] inas [symbol] | ABVista | 3-Phytase | Trichoderma ressei |
| [symbol] inas [symbol] EC | ABVista | 6-Phytase | E. coli gene |
| | | | expressed in |
| | | | Trichoderma ressei |
| Natu [symbol] s | [symbol] ASF | 3-Phytase | Asperg [symbol] us Niger |
| Natuzyme | Bioproton | Phytase (type | Trichoderma |
| | | not specified) | longibrachiatum/ |
| | | | Trichoderma ressei |
| OPTIPHOS | [symbol] pharma AD | 6-Phytase | E. coli gene |
| [symbol] | | | expressed in |
| | | | p [symbol] p [symbol] is |
| Phytase | DSM | 3-Phytase | A. conse [symbol] sus |
| sp1002 | | | gene expressed |
| | | | in [symbol] nu [symbol] polymorp [symbol] |
| Phyzyme XP | Danisco | 6-Phytase | E. coli gene |
| | | | expressed in |
| | | | sc [symbol] sa [symbol] omyces pombe |
| C [symbol] um | ABVista | 6-Phytase | E. coli gene |
| 2500D [symbol] | | | expressed in |
| 5000L | | | P [symbol] or |
| | | | Trichoderma |
| Ronozyme | DSM/Novozymes | 6-Phytase | Cl [symbol] er b [symbol] gene |
| Hi-Phos | | | expressed in |
| ( [symbol] L) | | | Aspergillus |
| | | | oryzae |
| Ronozyme | DSM/Novozymes | 6-Phytase | Penip [symbol] gene |
| NP | | | expressed in |
| | | | Aspergillus |
| | | | oryzae |
| Ronozyme P | DSM/Novozymes | 6-Phytase | Penip [symbol] gene |
| | | | expressed in |
| | | | Aspergillus |
| | | | oryzae |
| Ro [symbol] ble PHY | Ad [symbol] | 3-Phytase | Pen [symbol] c [symbol] um [symbol] un [symbol] um |

[symbol]

indicates data missing or illegible when filed

In one embodiment the phytase is a Citrobacter phytase derived from e.g. Citrobacter freundii, In some embodiments, C. freundii NCIMB 41247 and variants thereof e.g. as disclosed in WO2006/038062 (incorporated herein by reference) and WO2006/038128 (incorporated herein by reference), Citrobacter braakii YH-15 as disclosed in WO 2004/085638, Citrobacter braakii ATCC 51113 as disclosed in WO2006/037328 (incorporated herein by reference), as well as variants thereof e.g. as disclosed in WO2007/112739 (incorporated herein by reference) and WO2011/117396 (incorporated herein by reference), Citrobacter amalonaticus, In some embodiments, Citrobacter amalonaticus ATCC 25405 or Citrobacter amalonaticus ATCC 25407 as disclosed in WO2006037327 (incorporated herein by reference), Citrobacter gillenii, In some embodiments, Citrobacter gillenii DSM 13694 as disclosed in WO2006037327 (incorporated herein by reference), or Citrobacter intermedius, Citrobacter koseri, Citrobacter murliniae, Citrobacter rodentium, Citrobacter sedlakii, Citrobacter werkmanii, Citrobacter youngae, Citrobacter species polypeptides or variants thereof.

In some embodiments, the phytase is an E. coli phytase marketed under the name Phyzyme XP™ Danisco A/S. Alternatively, the phytase may be a Buttiauxella phytase, e.g. a Buttiauxella agrestis phytase, for example, the phytase enzymes taught in WO 2006/043178, WO 2008/097619, WO2009/129489, WO2008/092901, PCT/US2009/41011 or PCT/IB2010/051804, all of which are incorporated herein by reference. Alternatively, the phytase can be an engineered, robust high Tm clade phytase polypeptide, for example, a phytase disclosed in WO2020/106796, incorporated by reference herein.

In one embodiment, the phytase may be a phytase from Hafnia, e.g. from Hafnia alvei, such as the phytase enzyme(s) taught in US2008263688, which reference is incorporated herein by reference. In one embodiment, the phytase may be a phytase from Aspergillus, e.g. from Apergillus orzyae. In one embodiment, the phytase may be a phytase from Penicillium, e.g. from Penicillium funiculosum.

In some embodiments, the phytase is present in the feed or feed-additive compositions in range of about 200 FTU/kg to about 1000 FTU/kg feed. In some embodiments, about 300 FTU/kg feed to about 750 FTU/kg feed. In some embodiments, about 400 FTU/kg feed to about 500 FTU/kg feed. In one embodiment, the phytase is present in the feedstuff at more than about 200 FTU/kg feed, suitably more than about 300 FTU/kg feed, suitably more than about 400 FTU/kg feed. In one embodiment, the phytase is present in the feedstuff at less than about 1000 FTU/kg feed, suitably less than about 750 FTU/kg feed. In some embodiments, the phytase is present in the feed additive composition in range of about 40 FTU/g to about 40,000 FTU/g composition; about 80 FTU/g composition to about 20,000 FTU/g composition; about 100 FTU/g composition to about 10,000 FTU/g composition; and about 200 FTU/g composition to about 10,000 FTU/g composition. In one embodiment, the phytase is present in the feed additive composition at more than about 40 FTU/g composition, suitably more than about 60 FTU/g composition, suitably more than about 100 FTU/g composition, suitably more than about 150 FTU/g composition, suitably more than about 200 FTU/g composition. In one embodiment, the phytase is present in the feed additive composition at less than about 40,000 FTU/g composition, suitably less than about 20,000 FTU/g composition, suitably less than about 15,000 FTU/g composition, suitably less than about 10,000 FTU/g composition.

It will be understood that as used herein 1 FTU (phytase unit) is defined as the amount of enzyme required to release 1 mol of inorganic orthophosphate from a substrate in one minute under the reaction conditions defined in the ISO 2009 phytase assay-A standard assay for determining phytase activity and 1 FTU can be found at International Standard ISO/DIS 30024: 1-17, 2009. In one embodiment, the enzyme is classified using the E.C. classification above, and the E.C. classification designates an enzyme having that activity when tested in the assay taught herein for determining 1 FTU.

### D. Feed and Feed Additive Formulations

An enzyme, either alone or in combination with at least one direct fed microbial, an osmoregulator (e.g. betaine), one or more essential oils (e.g. cinnamaldehyde and/or thymol), aspartic acid (aspartate), ornithine, arginine, phosphate, acetate, a B vitamin (such as vitamin B1, B6, and/or B12) and/or least one other enzyme may be encapsulated for use in animal feed or a premix. In addition, an enzyme either alone or in combination with at least one direct fed microbial, an osmoregulator (e.g. betaine), one or more essential oils (e.g. cinnamaldehyde and/or thymol), aspartic acid (aspartate), ornithine, arginine, phosphate, acetate, a B vitamin (such as vitamin B1, B6, and/or B12) and/or in combination with least one protease, amylase, xylanase, beta-glucosidase, and/or phytase, whether or not encapsulated, may be in the form of a granule.

Animal feeds may include plant material such as corn, wheat, sorghum, soybean, canola, sunflower or mixtures of any of these plant materials or plant protein sources for poultry, pigs, ruminants, aquaculture and pets. The terms “animal feed,” “feedstuff” and “fodder” are used interchangeably and can comprise one or more feed materials selected from the group comprising a) cereals, such as small grains (e.g., wheat, barley, rye, oats and combinations thereof) and/or large grains such as maize or sorghum; b) by products from cereals, such as corn gluten meal, Distillers Dried Grains with Solubles (DDGS) (particularly corn based Distillers Dried Grains with Solubles (cDDGS), wheat bran, wheat middlings, wheat shorts, rice bran, rice hulls, oat hulls, palm kernel, and citrus pulp; c) protein obtained from sources such as soya, sunflower, peanut, lupin, peas, fava beans, cotton, canola, fish meal, dried plasma protein, meat and bone meal, potato protein, whey, copra, sesame; d) oils and fats obtained from vegetable and animal sources; and/or e) minerals and vitamins.

When used as, or in the preparation of, a feed, such as functional feed, the enzyme or feed additive composition of the present invention may be used in conjunction with one or more of: a nutritionally acceptable carrier, a nutritionally acceptable diluent, a nutritionally acceptable excipient, a nutritionally acceptable adjuvant, a nutritionally active ingredient. For example, there could be mentioned at least one component selected from the group consisting of a protein, a peptide, sucrose, lactose, sorbitol, glycerol, propylene glycol, sodium chloride, sodium sulfate, sodium acetate, sodium citrate, sodium formate, sodium sorbate, potassium chloride, potassium sulfate, potassium acetate, potassium citrate, potassium formate, potassium acetate, potassium sorbate, magnesium chloride, magnesium sulfate, magnesium acetate, magnesium citrate, magnesium formate, magnesium sorbate, sodium metabisulfite, methyl paraben and propyl paraben.

In a preferred embodiment the enzyme or feed additive composition of the present invention is admixed with a feed component to form a feedstuff. The term “feed component” as used herein means all or part of the feedstuff. Part of the feedstuff may mean one constituent of the feedstuff or more than one constituent of the feedstuff, e.g. 2 or 3 or 4 or more. In one embodiment the term “feed component” encompasses a premix or premix constituents.

Preferably, the feed may be a fodder, or a premix thereof, a compound feed, or a premix thereof. A feed additive composition according to the present invention may be admixed with a compound feed, a compound feed component or to a premix of a compound feed or to a fodder, a fodder component, or a premix of a fodder.

The term “fodder” as used herein means any food which is provided to an animal (rather than the animal having to forage for it themselves). Fodder encompasses plants that have been cut. Furthermore, fodder includes silage, compressed and pelleted feeds, oils and mixed rations, and also sprouted grains and legumes.

Fodder may be obtained from one or more of the plants selected from: corn (maize), alfalfa (Lucerne), barley, birdsfoot trefoil, brassicas, Chau moellier, kale, rapeseed (canola), rutabaga (swede), turnip, clover, alsike clover, red clover, subterranean clover, white clover, fescue, brome, millet, oats, sorghum, soybeans, trees (pollard tree shoots for tree-hay), wheat, and legumes.

The term “compound feed” means a commercial feed in the form of a meal, a pellet, nuts, cake or a crumble. Compound feeds may be blended from various raw materials and additives.

These blends are formulated according to the specific requirements of the target animal.

Compound feeds can be complete feeds that provide all the daily required nutrients, concentrates that provide a part of the ration (protein, energy) or supplements that only provide additional micronutrients, such as minerals and vitamins. The main ingredients used in compound feed are the feed grains, which include corn, wheat, canola meal, rapeseed meal, lupin, soybeans, sorghum, oats, and barley.

Suitably a “premix” as referred to herein may be a composition composed of microingredients such as vitamins, minerals, chemical preservatives, antibiotics, fermentation products, and other essential ingredients. Premixes are usually compositions suitable for blending into commercial rations.

As used herein the term “contacted” refers to the indirect or direct application of an enzyme, either alone or in combination with at least one direct fed microbial, an osmoregulator (e.g. betaine), one or more essential oils (e.g. cinnamaldehyde and/or thymol), aspartic acid (aspartate), ornithine, arginine, phosphate, acetate, a B vitamin (such as vitamin B1, B6, and/or B12) and/or least one other enzyme to a product (e.g. the feed). Examples of application methods which may be used, include, but are not limited to, treating the product in a material comprising the feed additive composition, direct application by mixing the feed additive composition with the product, spraying the feed additive composition onto the product surface or dipping the product into a preparation of the feed additive composition. In one embodiment the feed additive composition of the present invention is preferably admixed with the product (e.g. feedstuff). Alternatively, the feed additive composition may be included in the emulsion or raw ingredients of a feedstuff.

It is also possible that an enzyme, either alone or in combination with at least one direct fed microbial, an osmoregulator (e.g. betaine), one or more essential oils (e.g. cinnamaldehyde and/or thymol), aspartic acid (aspartate), ornithine, arginine, phosphate, acetate, a B vitamin (such as vitamin B1, B6, and/or B12) and/or least one other enzyme can be homogenized to produce a powder. In an alternative embodiment, an enzyme, either alone or in combination with at least one direct fed microbial, an osmoregulator (e.g. betaine), one or more essential oils (e.g. cinnamaldehyde and/or thymol), aspartic acid (aspartate), ornithine, arginine, phosphate, acetate, a B vitamin (such as vitamin B1, B6, and/or B12) and/or least one other enzyme can be formulated to granules as described in (referred to as TPT granules) or WO1997/016076 or WO1992/012645 incorporated herein by reference. “TPT” means Thermo Protection Technology.

In another aspect, when the feed additive composition is formulated into granules the granules comprise a hydrated barrier salt coated over the protein core. The advantage of such salt coating is improved thermo-tolerance, improved storage stability and protection against other feed additives otherwise having adverse effect on the enzyme. Preferably, the salt used for the salt coating has a water activity greater than 0.25 or constant humidity greater than 60% at 20 C. In some embodiments, the salt coating comprises Na2SO4.

A method of preparing an enzyme, either alone or in combination with at least one direct fed microbial, an osmoregulator (e.g. betaine), one or more essential oils (e.g. cinnamaldehyde and/or thymol), aspartic acid (aspartate), ornithine, arginine, phosphate, acetate, a B vitamin (such as vitamin B1, B6, and/or B12) and/or least one other enzyme may also comprise the further step of pelleting the powder. The powder may be mixed with other components known in the art. The powder, or mixture comprising the powder, may be forced through a die and the resulting strands are cut into suitable pellets of variable length.

Optionally, the pelleting step may include a steam treatment, or conditioning stage, prior to formation of the pellets. The mixture comprising the powder may be placed in a conditioner, e.g. a mixer with steam injection. The mixture is heated in the conditioner up to a specified temperature, such as from 60-100 C, typical temperatures would be 70 C, 80 C, 85 C, 90 C or 95 C. The residence time can be variable from seconds to minutes and even hours. Such as 5 seconds, 10 seconds, 15 seconds, 30 seconds, 1 minute, 2 minutes, 5 minutes, 10 minutes, 15 minutes, 30 minutes and 1 hour.

It will be understood by the skilled person that different animals require different feedstuffs, and even the same animal may require different feedstuffs, depending upon the purpose for which the animal is reared. Optionally, the feedstuff may also contain additional minerals such as, for example, calcium and/or additional vitamins. In some embodiments, the feedstuff is a corn soybean meal, wheat, or mixed grain mix.

Feedstuff is typically produced in feed mills in which raw materials are first ground to a suitable particle size and then mixed with appropriate additives. The feedstuff may then be produced as a mash or pellets; the later typically involves a method by which the temperature is raised to a target level and then the feed is passed through a die to produce pellets of a particular size. The pellets are allowed to cool. Subsequently liquid additives such as fat and enzyme may be added. Production of feedstuff may also involve an additional step that includes extrusion or expansion prior to pelleting, in particular by suitable techniques that may include at least the use of steam.

The feedstuff may be a feedstuff for a monogastric animal, such as poultry (for example, broiler, layer, broiler breeders, turkey, duck, geese, water fowl), and swine (all age categories), a ruminant such as cattle (e.g. cows or bulls (including calves)), horses, sheep, a pet (for example dogs, cats) or fish (for example agastric fish, gastric fish, freshwater fish such as salmon, cod, trout and carp, e.g. koi carp, marine fish such as sea bass, and crustaceans such as shrimps, mussels and scallops).

The feed additive composition and/or the feedstuff comprising the same may be used in any suitable form. The feed additive composition may be used in the form of solid or liquid preparations or alternatives thereof Examples of solid preparations include powders, pastes, boluses, capsules, pellets, tablets, dusts, and granules which may be wettable, spray-dried or freeze-dried. Examples of liquid preparations include, but are not limited to, aqueous, organic or aqueous-organic solutions, suspensions and emulsions.

In some applications, the feed additive compositions may be mixed with feed or administered in the drinking water (for example, drinking water derived from water wells, fountains, shallow wells, semi-artesian and artesian wells, municipal water supplies, lakes or creeks). In other embodiments, one or more components of the feed additive composition (e.g. one or more of an osmoregulator, essential oil(s), DFM, or feed enzyme) is administered in the drinking water and one or more components of the feed additive composition (e.g. one or more of an osmoregulator, essential oil(s), DFM, or feed enzyme) is administered in the feed concurrently or simultaneously. When water line delivery is contemplated, administration of the feed additive composition can include, without limitation, one or more of mixing the composition into water, rehydrating the composition components (e.g., the DFMs), adding hydrated composition to a medicator and administering it into a water line via a dosatron or other pumping means.

A feed additive composition, comprising admixing a DFM (such as a DMF comprising Bifidobacterium animalis subsp. lactis and/or a Lactobacillus acidophilus) and/or one or more of an osmoregulator (e.g. betaine), one or more essential oils (e.g. cinnamaldehyde and/or thymol), and/or one or more enzymes (e.g. protease, xylanase, beta-glucanase, phytase, and amylase), aspartic acid (aspartate), ornithine, arginine, phosphate acetate, and/or a B vitamin (such as vitamin B1, B6, and/or B12) as taught herein with a feed acceptable carrier, diluent or excipient, and (optionally) packaging.

The feedstuff and/or feed additive composition may be combined with at least one mineral and/or at least one vitamin. The compositions thus derived may be referred to herein as a premix. The feedstuff may comprise at least 0.0001% by weight of the feed additive. Suitably, the feedstuff may comprise at least 0.0005%; at least 0.0010%; at least 0.0020%; at least 0.0025%; at least 0.0050%; at least 0.0100%; at least 0.020%; at least 0.100% at least 0.200%; at least 0.250%; at least 0.500% by weight of the feed additive.

Preferably, a food or feed additive composition may further comprise at least one physiologically acceptable carrier. The physiologically acceptable carrier is preferably selected from at least one of maltodextrin, limestone (calcium carbonate), cyclodextrin, wheat or a wheat component, sucrose, starch, Na2SO4, Talc, PVA and mixtures thereof. In a further embodiment, the food or feed additive may further comprise a metal ion chelator. The metal ion chelator may be selected from EDTA or citric acid.

In some embodiments the food or feed additive composition comprises one or more enzymes (such as a protease, phytase, xylanase, glucoamylase, or amylase) at a level of at least 0.0001 g/kg, 0.001 g/kg, at least 0.01 g/kg, at least 0.1 g/kg, at least 1 g/kg, at least 5 g/kg, at least 7.5 g/kg, at least 10.0 g/kg, at least 15.0 g/kg, at least 20.0 g/kg, at least 25.0 g/kg.

In some embodiments, the food or feed additive comprises one or more enzymes (such as a protease, phytase, xylanase, glucoamylase, or amylase) at a level such that when added to a food or feed material, the feed material comprises the one or more enzymes in a range of 1-500 mg/kg, 1-100 mg/kg, 2-50 mg/kg or 2-10 mg/kg. In some embodiments of the present invention the food or feed material comprises at least 100, 1000, 2000, 3000, 4000, 5000, 10000, 20000, 30000, 50000, 100000, 500000, 1000000 or 2000000 Units of enzyme per kilogram feed or food material. In some embodiments, one unit of a-1,2-fucosidase activity can be defined as the amount of enzyme that can catalyze release of one mole substrate per minute under standard assay conditions.

Formulations comprising any enzyme as described herein may be made in any suitable way to ensure that the formulation comprises active enzymes. Such formulations may be as a liquid, a dry powder or a granule. Preferably, the feed additive composition is in a solid form suitable for adding on or to a feed pellet.

Dry powder or granules may be prepared by means known to those skilled in the art, such as, high shear granulation, drum granulation, extrusion, spheronization, fluidized bed agglomeration, fluidized bed spray drying.

Feed additive composition described herein can be formulated to a dry powder or granules as described in WO2007/044968 (referred to as TPT granules) or WO1997/016076 or WO1992/012645 (each of which is incorporated herein by reference).

In one embodiment animal feed may be formulated to a granule for feed compositions comprising: a core; an active agent; and at least one coating, the active agent of the granule retaining at least 50% activity, at least 60% activity, at least 70% activity, at least 80% activity after conditions selected from one or more of a) a feed pelleting process, b) a steam-heated feed pretreatment process, c) storage, d) storage as an ingredient in an unpelleted mixture, and e) storage as an ingredient in a feed base mix or a feed premix comprising at least one compound selected from trace minerals, organic acids, reducing sugars, vitamins, choline chloride, and compounds which result in an acidic or a basic feed base mix or feed premix.

With regard to the granule at least one coating may comprise a moisture hydrating material that constitutes at least 55% w/w of the granule; and/or at least one coating may comprise two coatings. The two coatings may be a moisture hydrating coating and a moisture barrier coating. In some embodiments, the moisture hydrating coating may be between 25% and 60% w/w of the granule and the moisture barrier coating may be between 2% and 15% w/w of the granule. The moisture hydrating coating may be selected from inorganic salts, sucrose, starch, and maltodextrin and the moisture barrier coating may be selected from polymers, gums, whey and starch.

The feed additive composition may be formulated to a granule for animal feed comprising: a core; an active agent, the active agent of the granule retaining at least 80% activity after storage and after a steam-heated pelleting process where the granule is an ingredient; a moisture barrier coating; and a moisture hydrating coating that is at least 25% w/w of the granule, the granule having a water activity of less than 0.5 prior to the steam-heated pelleting process.

The granule may have a moisture barrier coating selected from polymers and gums and the moisture hydrating material may be an inorganic salt. The moisture hydrating coating may be between 25% and 45% w/w of the granule and the moisture barrier coating may be between 2% and 10% w/w of the granule.

A granule may be produced using a steam-heated pelleting process which may be conducted between 85 C and 95 C for up to several minutes.

Alternatively, the composition is in a liquid formulation suitable for consumption preferably such liquid consumption contains one or more of the following: a buffer, salt, sorbitol and/or glycerol.

Also, the feed additive composition may be formulated by applying, e.g. spraying, the enzyme(s) onto a carrier substrate, such as ground wheat for example. In one embodiment the feed additive composition may be formulated as a premix. By way of example only the premix may comprise one or more feed components, such as one or more minerals and/or one or more vitamins.

In one embodiment at least one DFM and/or enzyme such as a protease, amylase, xylanase, beta-glucosidase, and/or phytase, are formulated with at least one physiologically acceptable carrier selected from at least one of maltodextrin, limestone (calcium carbonate), cyclodextrin, wheat or a wheat component, sucrose, starch, Na2SO4, Talc, PVA, sorbitol, benzoate, sorbate, glycerol, sucrose, propylene glycol, 1,3-propane diol, glucose, parabens, sodium chloride, citrate, acetate, phosphate, calcium, metabisulfite, formate and mixtures thereof.

Pharmaceutically acceptable salts can be used, for example mineral acid salts, such as hydrochlorides, hydrobromides, phosphates and sulphates, or salts of organic acids, such as acetates, propionates, malonates and benzoates. Pharmaceutically acceptable carriers in feed additive and/or water line compositions may additionally contain liquids such as water, saline, glycerol and ethanol. Additionally, auxiliary substances, such as wetting or emulsifying agents or pH buffering substances, may be present in such compositions. Such carriers enable the pharmaceutical compositions to be formulated as tablets, pills, dragees, capsules, liquids, gels, syrups, slurries and suspensions, for ingestion by the patient. Once formulated, the compositions of the invention can be administered directly to the subject. The subjects to be treated can be animals. However, in one or more embodiments the compositions are adapted for administration to human subjects.

### III. Methods

### A. Methods for Treating or Preventing Necrotic Enteritis

The present disclosure relates to a method for treating or preventing necrotic enteritis in a subject comprising administering to the animal an effective amount of a feed, feed additive composition, or premix containing a direct fed microbial (DFM) comprising Bifidobacterium animalis subsp. lactis and/or a Lactobacillus acidophilus. However, in some embodiments, the DFM comprising Bifidobacterium animalis subsp. lactis and/or a Lactobacillus acidophilus can be delivered to the subject in drinking water via a water line. In another embodiment, the method relates to treating or preventing necrotic enteritis in a subject comprising administering to the animal an effective amount of water (e.g. via water line delivery) containing a feed, feed additive composition, or premix containing a direct fed microbial (DFM) comprising Bifidobacterium animalis subsp. lactis and/or a Lactobacillus acidophilus. The feed, feed additive composition, or premix can additionally include one or more of an osmoregulator (e.g. betaine), one or more essential oils (e.g. cinnamaldehyde and/or thymol), and one or more enzymes (e.g. protease, xylanase, beta-glucanase, phytase, and amylase).

In some embodiments, administering an effective amount of a feed or feed additive composition containing a DFM comprising Bifidobacterium animalis subsp. lactis and/or a Lactobacillus acidophilus (or the secretome of a Bifidobacterium animalis subsp. lactis and/or a Lactobacillus acidophilus) to a subject results in decreased incidence of necrotic enteritis (such as a decrease by any of about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, or 100 inclusive of all values in between these percentages) compared to the incidence of necrotic enteritis present in a subject that has not been administered an effective amount of a feed or feed additive composition containing a DFM comprising Bifidobacterium animalis subsp. lactis and/or a Lactobacillus acidophilus (or the secretome of a Bifidobacterium animalis subsp. lactis and/or a Lactobacillus acidophilus). The feed or feed additive composition can additionally include one or more of an osmoregulator (e.g. betaine), one or more essential oils (e.g. cinnamaldehyde and/or thymol), and one or more enzymes (e.g. protease, xylanase, beta-glucanase, phytase, and amylase). The subject can be poultry (e.g. layers or broilers) or swine (e.g. a piglet, a growing pig, or a sow).

In one embodiment, treating or preventing necrotic enteritis comprises preventing or reducing intestinal lesions in the subject. Specifically, administering an effective amount of a feed or feed additive composition containing a DFM comprising Bifidobacterium animalis subsp. lactis and/or a Lactobacillus acidophilus (or the secretome of a Bifidobacterium animalis subsp. lactis and/or a Lactobacillus acidophilus) to a subject results in decreased intestinal lesions (i.e. decreased number and/or decreased in severity) (such as a decrease by any of about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, or 100 inclusive of all values in between these percentages) compared to the incidence of necrotic enteritis present in a subject that has not been administered an effective amount of a feed or feed additive composition containing a DFM comprising Bifidobacterium animalis subsp. lactis and/or a Lactobacillus acidophilus (or the secretome of a Bifidobacterium animalis subsp. lactis and/or a Lactobacillus acidophilus). The feed or feed additive composition can additionally include one or more of an osmoregulator (e.g. betaine), one or more essential oils (e.g. cinnamaldehyde and/or thymol), and one or more enzymes (e.g. protease, xylanase, beta-glucanase, phytase, and amylase). The subject can be poultry (e.g. layers or broilers) or swine (e.g. a piglet, a growing pig, or a sow).

In another embodiment, treating or preventing necrotic enteritis comprises reducing feed conversion ratio (FCR) in the subject. Specifically, administering an effective amount of a feed or feed additive composition containing a DFM comprising Bifidobacterium animalis subsp. lactis and/or a Lactobacillus acidophilus (or the secretome of a Bifidobacterium animalis subsp. lactis and/or a Lactobacillus acidophilus) to a subject results in decreased FCR (such as a decrease by any of about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, or 100 inclusive of all values in between these percentages) compared to the FCR in a subject that has not been administered an effective amount of a feed or feed additive composition containing a DFM comprising Bifidobacterium animalis subsp. lactis and/or a Lactobacillus acidophilus (or the secretome of a Bifidobacterium animalis subsp. lactis and/or a Lactobacillus acidophilus). The feed or feed additive composition can additionally include one or more of an osmoregulator (e.g. betaine), one or more essential oils (e.g. cinnamaldehyde and/or thymol), and one or more enzymes (e.g. protease, xylanase, beta-glucanase, phytase, and amylase). The subject can be poultry (e.g. layers or broilers) or swine (e.g. a piglet, a growing pig, or a sow).

In another embodiment, treating or preventing necrotic enteritis comprises reducing mortality in the subject or a group of subjects. Specifically, administering an effective amount of a feed or feed additive composition containing a DFM comprising Bifidobacterium animalis subsp. lactis and/or a Lactobacillus acidophilus (or the secretome of a Bifidobacterium animalis subsp. lactis and/or a Lactobacillus acidophilus) to a subject results in decreased mortality (such as a decrease by any of about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, or 100 inclusive of all values in between these percentages) compared to the mortality in a subject or group of subjects that has not been administered an effective amount of a feed or feed additive composition containing a DFM comprising Bifidobacterium animalis subsp. lactis and/or a Lactobacillus acidophilus (or the secretome of a Bifidobacterium animalis subsp. lactis and/or a Lactobacillus acidophilus). The feed or feed additive composition can additionally include one or more of an osmoregulator (e.g. betaine), one or more essential oils (e.g. cinnamaldehyde and/or thymol), and one or more enzymes (e.g. protease, xylanase, beta-glucanase, phytase, and amylase). The subject can be poultry (e.g. layers or broilers) or swine (e.g. a piglet, a growing pig, or a sow).

In another embodiment, treating or preventing necrotic enteritis comprises increasing feed efficiency in the subject. Specifically, administering an effective amount of a feed or feed additive composition containing a DFM comprising Bifidobacterium animalis subsp. lactis and/or a Lactobacillus acidophilus (or the secretome of a Bifidobacterium animalis subsp. lactis and/or a Lactobacillus acidophilus) to a subject results in increased feed efficiency (such as an increase by any of about 5%, 10%, 15%, 20%, 25%, 30%, 35%, 40%, 45%, 50%, 55%, 60%, 65%, 70%, 75%, 80%, 85%, 90%, 95%, 100%, 105%, 110%, 115%, 120%, 125%, 130%, 135%, 140%, 145%, 150%, 155%, 160%, 165%, 170%, 175%, 180%, 185%, 190%, 195%, 200%, 250%, 300%, 350%, 400%, 450%, 500%, 550%, 600%, 650%, 700%, 750%, 800%, 850%, 900%, 950%, 1000%, 1100%, 1200%, 1300%, 1400%, 1500%, 1600%, 1700%, 1800%, 1900%, 2000%, 2100%, 2200%, 2300%, 2400%, 2500% inclusive of all values in between these percentages) compared to the feed efficiency in a subject that has not been administered an effective amount of a feed or feed additive composition containing a DFM comprising Bifidobacterium animalis subsp. lactis and/or a Lactobacillus acidophilus (or the secretome of a Bifidobacterium animalis subsp. lactis and/or a Lactobacillus acidophilus). The feed or feed additive composition can additionally include one or more of an osmoregulator (e.g. betaine), one or more essential oils (e.g. cinnamaldehyde and/or thymol), and one or more enzymes (e.g. protease, xylanase, beta-glucanase, phytase, and amylase). The subject can be poultry (e.g. layers or broilers) or swine (e.g. a piglet, a growing pig, or a sow).

In another embodiment, treating or preventing necrotic enteritis comprises increasing final slaughter weight in the subject or the subject's weight entering the final phase(s) of feeding. Specifically, administering an effective amount of a feed or feed additive composition containing a DFM comprising Bifidobacterium animalis subsp. lactis and/or a Lactobacillus acidophilus (or the secretome of a Bifidobacterium animalis subsp. lactis and/or a Lactobacillus acidophilus) to a subject results in increased final slaughter weight (such as an increase by any of about 5%, 10%, 15%, 20%, 25%, 30%, 35%, 40%, 45%, 50%, 55%, 60%, 65%, 70%, 75%, 80%, 85%, 90%, 95%, 100%, 105%, 110%, 115%, 120%, 125%, 130%, 135%, 140%, 145%, 150%, 155%, 160%, 165%, 170%, 175%, 180%, 185%, 190%, 195%, 200%, 250%, 300%, 350%, 400%, 450%, 500%, 550%, 600%, 650%, 700%, 750%, 800%, 850%, 900%, 950%, 1000%, 1100%, 1200%, 1300%, 1400%, 1500%, 1600%, 1700%, 1800%, 1900%, 2000%, 2100%, 2200%, 2300%, 2400%, 2500% inclusive of all values in between these percentages) compared to the final slaughter weight in a subject that has not been administered an effective amount of a feed or feed additive composition containing a DFM comprising Bifidobacterium animalis subsp. lactis and/or a Lactobacillus acidophilus (or the secretome of a Bifidobacterium animalis subsp. lactis and/or a Lactobacillus acidophilus). The feed or feed additive composition can additionally include one or more of an osmoregulator (e.g. betaine), one or more essential oils (e.g. cinnamaldehyde and/or thymol), and one or more enzymes (e.g. protease, xylanase, beta-glucanase, phytase, and amylase). The subject can be poultry (e.g. layers or broilers) or swine (e.g. a piglet, a growing pig, or a sow).

In another embodiment, treating or preventing necrotic enteritis comprises increasing weight gain in the subject. Specifically, administering an effective amount of a feed or feed additive composition containing a DFM comprising Bifidobacterium animalis subsp. lactis and/or a Lactobacillus acidophilus (or the secretome of a Bifidobacterium animalis subsp. lactis and/or a Lactobacillus acidophilus) to a subject results in increased weight gain (such as an increase by any of about 5%, 10%, 15%, 20%, 25%, 30%, 35%, 40%, 45%, 50%, 55%, 60%, 65%, 70%, 75%, 80%, 85%, 90%, 95%, 100%, 105%, 110%, 115%, 120%, 125%, 130%, 135%, 140%, 145%, 150%, 155%, 160%, 165%, 170%, 175%, 180%, 185%, 190%, 195%, 200%, 250%, 300%, 350%, 400%, 450%, 500%, 550%, 600%, 650%, 700%, 750%, 800%, 850%, 900%, 950%, 1000%, 1100%, 1200%, 1300%, 1400%, 1500%, 1600%, 1700%, 1800%, 1900%, 2000%, 2100%, 2200%, 2300%, 2400%, 2500% inclusive of all values in between these percentages) compared to weight gain in a subject that has not been administered an effective amount of a feed or feed additive composition containing a DFM comprising Bifidobacterium animalis subsp. lactis and/or a Lactobacillus acidophilus (or the secretome of a Bifidobacterium animalis subsp. lactis and/or a Lactobacillus acidophilus). The feed or feed additive composition can additionally include one or more of an osmoregulator (e.g. betaine), one or more essential oils (e.g. cinnamaldehyde and/or thymol), and one or more enzymes (e.g. protease, xylanase, beta-glucanase, phytase, and amylase). The subject can be poultry (e.g. layers or broilers) or swine (e.g. a piglet, a growing pig, or a sow).

In another embodiment, treating or preventing necrotic enteritis comprises reducing expression of Clostridium perfringens necrotic enteritis B-like toxin (NetB) in the subject. NetB is produced by C. perfringens toxinotype A strains and, to a lesser extent, by strains of type C (Kaldhusdal et al. (1999) FEMS Immunol Med Microbial vol 24: 337-343). The protein is 322 amino acids long in its active form and has an estimated molecular weight of 36.5 kDa. Although the molecular basis of toxicity is still little understood, several studies suggest that NetB is a new member of the small β-pore-forming toxins (β-PFTs) as it is able to form pores in membranes and shares amino acid sequence similarity with several other related members of the small pore-forming toxins family (38% identity with the beta toxin from C. perfringens, 40% identity with the C. perfringens delta toxin, and 31% identity with the alpha toxin from S. aureus) (Keybur et al. (2008) PLoS Pathog vol 4: e26; Manich et al. (2008) PLoS One vol 3: e3764). It was initially assumed that the alpha toxin, which is produced by the same bacterium, is the major virulence factor for causing NE, but experiments with an alpha toxin mutant showed that this strain was still virulent and able to cause disease (Keyburn et al. (2006) Infect Immun vol 74: 6496-6500). In contrast, a netB mutant was not capable of causing NE, whereas the wild type and the complemented mutant could (Keyburn et al. (2008) PLoS Pathog vol 4: e26; Manich et al. (2008) PLoS One vol 3: e3764). However, it is still unsettled as to whether NetB is the key virulence factor for causing NE. as in some cases it was reported that even C. perfringens strains without the netB gen were still capable of virulence (Cooper & Songer (2009) Vet Microbiol Vol 142: 323-328). Moreover, immunization studies with alpha toxin and other antigens, such as a hypothetical zinc metalloprotease and a pyruvate-ferredoxin oxidoreductase, have been identified to moderately protect chicken from developing NE (Cooper et al. (2009) Vet Microbiol vol 133: 92-97; Zekarias et al. (2008) Clin Vaccine Immunol vol 15: 805-816; Kulkarni et al. (2010) Clin Vaccine Immunol vol 17: 205-214; Kulkarni et al. (2007) Clin Vaccine Immunol vol 14: 1070-1077).

In some embodiments, administering an effective amount of a feed or feed additive composition containing a DFM comprising Bifidobacterium animalis subsp. lactis and/or a Lactobacillus acidophilus (or the secretome of a Bifidobacterium animalis subsp. lactis and/or a Lactobacillus acidophilus) to a subject results in reduced expression of NetB (such as a decrease by any of about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, or 100%, inclusive of all values in between these percentages) compared to expression of NetB in a subject that has not been administered an effective amount of a feed or feed additive composition containing a DFM comprising Bifidobacterium animalis subsp. lactis and/or a Lactobacillus acidophilus (or the secretome of a Bifidobacterium animalis subsp. lactis and/or a Lactobacillus acidophilus). The feed or feed additive composition can additionally include one or more of an osmoregulator (e.g. betaine), one or more essential oils (e.g. cinnamaldehyde and/or thymol), and one or more enzymes (e.g. protease, xylanase, beta-glucanase, phytase, and amylase). The subject can be poultry (e.g. layers or broilers or turkeys) or swine (e.g. a piglet, a growing pig, or a sow).

### B. Methods for Treating or Preventing Coccidiosis

Coccidiosis is an enteric disease of domesticated birds caused by infection with intracellular protozoan parasites of the genus Eimeria. Coccidiosis is the most economically devastating parasitic disease of domesticated birds. It is estimated that anticoccidial medications and losses due to coccidiosis cost the poultry industry hundreds of millions of dollars every year. The disease spreads from one animal to another by contact with infected feces or ingestion of infected tissue. Diarrhea, which may become bloody in severe cases, is the primary symptom. Most animals infected with coccidia are asymptomatic, but young or immunocompromised animals may suffer severe symptoms and death.

The present disclosure relates to a method for treating or preventing coccidiosis in a subject comprising administering to the animal an effective amount of a feed, feed additive composition, or premix containing a direct fed microbial (DFM) comprising Bifidobacterium animalis subsp. lactis and/or a Lactobacillus acidophilus (or the secretome of a Bifidobacterium animalis subsp. lactis and/or a Lactobacillus acidophilus). The feed, feed additive composition, or premix can additionally include one or more of an osmoregulator (e.g. betaine), one or more essential oils (e.g. cinnamaldehyde and/or thymol), and one or more enzymes (e.g. protease, xylanase, beta-glucanase, phytase, and amylase.

In some embodiments, administering an effective amount of a feed or feed additive composition containing a DFM comprising Bifidobacterium animalis subsp. lactis and/or a Lactobacillus acidophilus (or the secretome of a Bifidobacterium animalis subsp. lactis and/or a Lactobacillus acidophilus) to a subject or group of subjects results in decreased onset or incidence of coccidiosis (such as a decrease by any of about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, or 100 inclusive of all values in between these percentages) compared to the incidence of coccidiosis present in a subject or group of subjects that has not been administered an effective amount of a feed or feed additive composition containing a DFM comprising Bifidobacterium animalis subsp. lactis and/or a Lactobacillus acidophilus (or the secretome of a Bifidobacterium animalis subsp. lactis and/or a Lactobacillus acidophilus). The feed or feed additive composition can additionally include one or more of an osmoregulator (e.g. betaine), one or more essential oils (e.g. cinnamaldehyde and/or thymol), and one or more enzymes (e.g. protease, xylanase, beta-glucanase, phytase, and amylase). The subject can be poultry (e.g. layers or broilers) or swine (e.g. a piglet, a growing pig, or a sow).

C. Methods for Decreasing NetB Toxin Expression in Clostridium perfringens

Also provided herein are methods for decreasing necrotic enteritis B-like toxin (NetB) expression in Clostridium perfringens by contacting a C. perfringens cell with one or more of aspartic acid (aspartate), ornithine, arginine, phosphate acetate, a B vitamin, and/or the secretome of a Bifidobacterium animalis subsp. lactis and/or a Lactobacillus acidophilus.

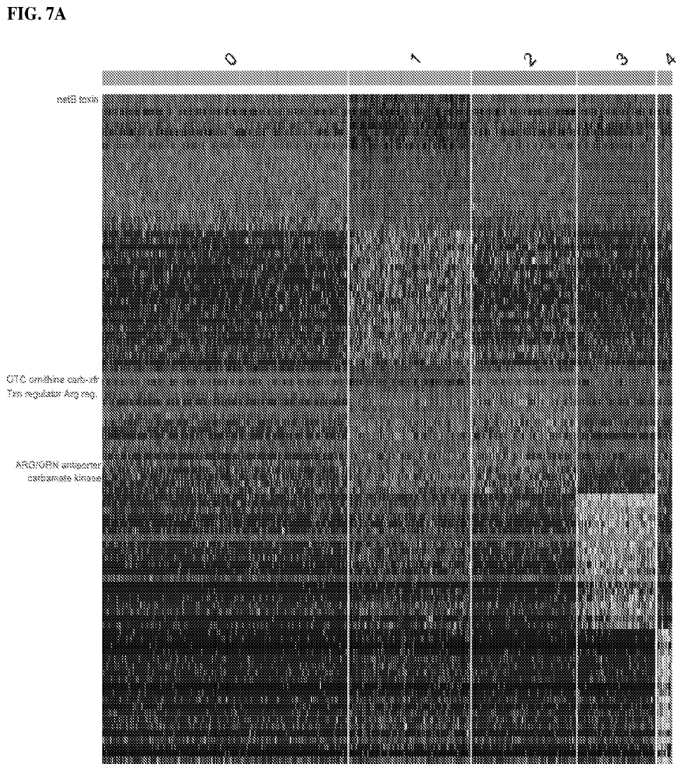

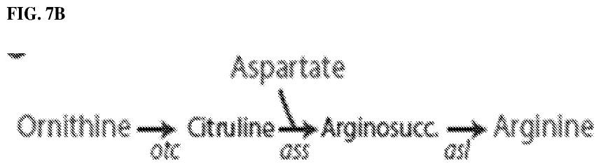

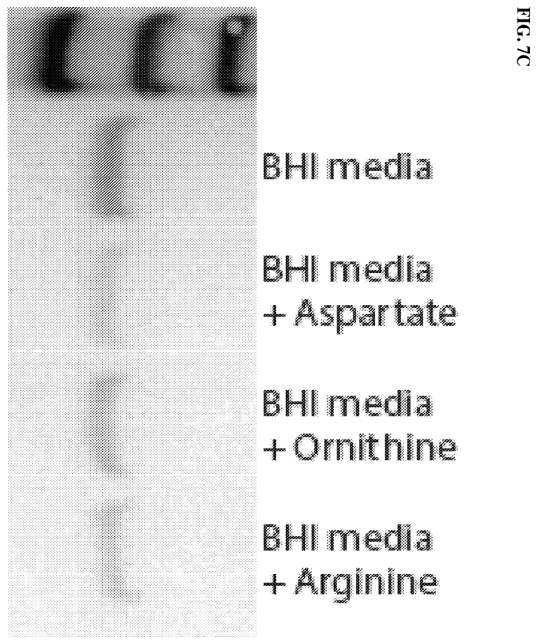

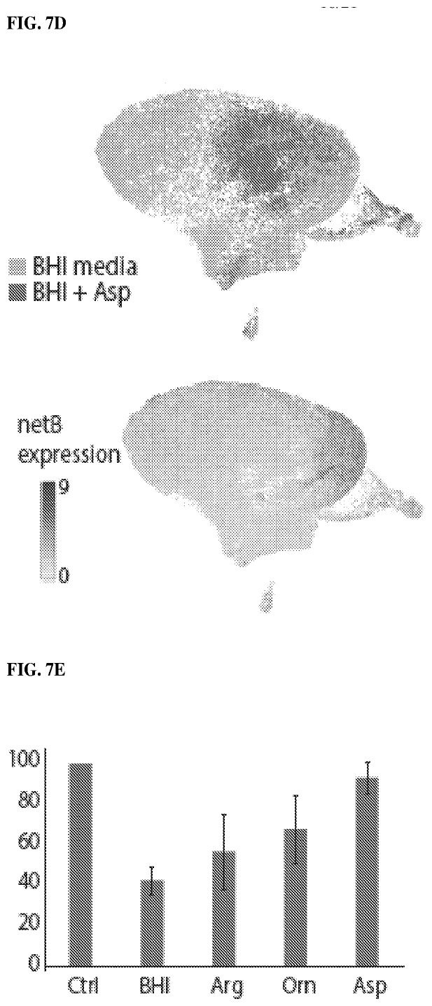

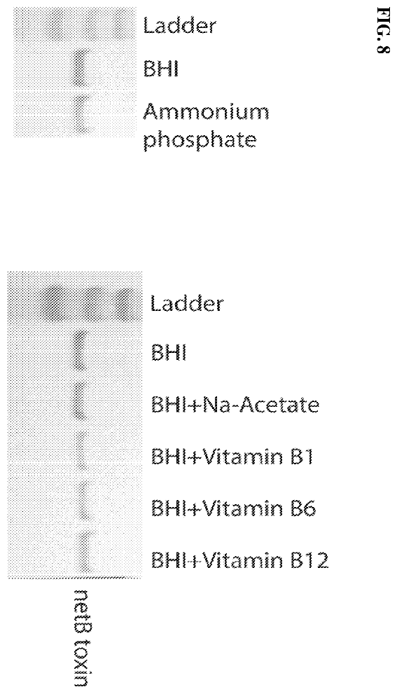

Contacting a C. perfingens cell with aspartic acid, or its ionic form aspartate, reduces C. perfingens NetB toxin expression. Aspartic acid is an α-amino acid that is used in the biosynthesis of proteins. In microorganisms, aspartate is the precursor to several amino acids, including methionine, threonine, isoleucine, lysine, asparagine, and arginine. The conversion of aspartate to these other amino acids begins with reduction of aspartate to its “semialdehyde”, O₂CCH(NH₂)CH₂CHO. Asparagine is derived from aspartate via transamidation. Aspartate's role in arginine biosynthesis is shown in FIG. 7B. Accordingly, in some embodiments, contacting a C. perfingens cell with aspartic acid, or its ionic form aspartate, decreases C. perfingens NetB toxin expression (such as a decrease by any of about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, or 100 inclusive of all values in between these percentages) compared to C. perfingens NetB toxin expression in cells that are not contacted with aspartic acid. In some embodiments, the C. perfingens cells are further contacted with an osmoregulatory (such as betaine) or an essential oil (such as thymol or cinnamaldehyde). In further embodiments, the C. perfingens cells are located in the gut of poultry (for example, a chicken, such as a broiler or layer).

Contacting a C. perfingens cell with ornithine, reduces C. perfingens NetB toxin expression. Ornithine is a non-proteinogenic amino acid that plays a role in arginine biosynthesis (see FIG. 7B). Accordingly, in some embodiments, contacting a C. perfingens cell with ornithine decreases C. perfingens NetB toxin expression (such as a decrease by any of about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, or 100 inclusive of all values in between these percentages) compared to C. perfingens NetB toxin expression in cells that are not contacted with ornithine. In some embodiments, the C. perfingens cells are further contacted with an osmoregulatory (such as betaine) or an essential oil (such as thymol or cinnamaldehyde). In further embodiments, the C. perfingens cells are located in the gut of poultry (for example, a chicken, such as a broiler or layer).

Contacting a C. perfingens cell with arginine reduces C. perfingens NetB toxin expression. Arginine is an α-amino acid that is used in the biosynthesis of proteins. Accordingly, in some embodiments, contacting a C. perfingens cell with arginine decreases C. perfingens NetB toxin expression (such as a decrease by any of about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, or 100 inclusive of all values in between these percentages) compared to C. perfingens NetB toxin expression in cells that are not contacted with arginine. In some embodiments, the C. perfingens cells are further contacted with an osmoregulatory (such as betaine) or an essential oil (such as thymol or cinnamaldehyde). In further embodiments, the C. perfingens cells are located in the gut of poultry (for example, a chicken, such as a broiler or layer).

Contacting a C. perfingens cell with a source of phosphate reduces C. perfingens NetB toxin expression. The phosphate or orthophosphate ion [PO₄]³⁻ is derived from phosphoric acid by the removal of three protons H⁺. Removal of one or two protons gives the dihydrogen phosphate ion [H₂PO₄]⁻ and the hydrogen phosphate ion [HPO₄]²⁻ ion, respectively. These names are also used for salts of those anions, such as, without limitation, ammonium dihydrogen phosphate and trisodium phosphate. Accordingly, in some embodiments, contacting a C. perfingens cell with a source of phosphate decreases C. perfingens NetB toxin expression (such as a decrease by any of about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, or 100 inclusive of all values in between these percentages) compared to C. perfingens NetB toxin expression in cells that are not contacted with a source of phosphate. In some embodiments, the C. perfingens cells are further contacted with an osmoregulatory (such as betaine) or an essential oil (such as thymol or cinnamaldehyde). In further embodiments, the C. perfingens cells are located in the gut of poultry (for example, a chicken, such as a broiler or layer).

Contacting a C. perfingens cell with acetate reduces C. perfingens NetB toxin expression. Acetate is a salt formed by the combination of acetic acid with a base (e.g. alkaline, earthy, metallic, nonmetallic or radical base). In some microorganisms, pyruvate is converted into acetyl-coenzyme A (acetyl-CoA) by the enzyme pyruvate dehydrogenase. This acetyl-CoA is then converted into acetate whilst producing ATP by substrate-level phosphorylation. Acetate formation requires two enzymes: phosphate acetyltransferase and acetate kinase. Accordingly, in some embodiments, contacting a C. perfingens cell with acetate decreases C. perfingens NetB toxin expression (such as a decrease by any of about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, or 100 inclusive of all values in between these percentages) compared to C. perfingens NetB toxin expression in cells that are not contacted with acetate. In some embodiments, the C. perfingens cells are further contacted with an osmoregulatory (such as betaine) or an essential oil (such as thymol or cinnamaldehyde). In further embodiments, the C. perfingens cells are located in the gut of poultry (for example, a chicken, such as a broiler or layer).

Contacting a C. perfingens cell with one or more B vitamins reduces C. perfingens NetB toxin expression. B vitamins are a class of water-soluble vitamins that play important roles in cell metabolism. Non-limiting examples of B vitamins include vitamin B₁, B₆, and/or B₁₂. Accordingly, in some embodiments, contacting a C. perfingens cell with one or more B vitamins decreases C. perfingens NetB toxin expression (such as a decrease by any of about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, or 100 inclusive of all values in between these percentages) compared to C. perfingens NetB toxin expression in cells that are not contacted with one or more B vitamins. In some embodiments, the C. perfingens cells are further contacted with an osmoregulatory (such as betaine) or an essential oil (such as thymol or cinnamaldehyde). In further embodiments, the C. perfingens cells are located in the gut of poultry (for example, a chicken, such as a broiler or layer).

Contacting a C. perfingens cell with the secretome of a Bifidobacterium animalis subsp. lactis and/or a Lactobacillus acidophilus (e.g. Bifidobacterium animalis subsp. lactis strain B1-04 and/or Lactobacillus acidophilus strain NCFM) reduces C. perfingens NetB toxin expression. Accordingly, in some embodiments, contacting a C. perfingens cell with the secretome of a Bifidobacterium animalis subsp. lactis and/or a Lactobacillus acidophilus decreases C. perfingens NetB toxin expression (such as a decrease by any of about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, or 100 inclusive of all values in between these percentages) compared to C. perfingens NetB toxin expression in cells that are not contacted with the secretome of a Bifidobacterium animalis subsp. lactis and/or a Lactobacillus acidophilus. In some embodiments, the C. perfingens cells are further contacted with an osmoregulatory (such as betaine) or an essential oil (such as thymol or cinnamaldehyde). In further embodiments, the C. perfingens cells are located in the gut of poultry (for example, a chicken, such as a broiler or layer).

The invention can be further understood by reference to the following examples, which are provided by way of illustration and are not meant to be limiting.

### EXAMPLES

### Example 1: Use of Betaine, Essential Oils and DFMs to Reduce the Negative Effects of Necrotic Enteritis

This Example demonstrates that when used in specific combination(s) betaine, essential oils and DFMs reduce the negative effects of necrotic enteritis (NE) as evidenced by improved lesion scores and bird performance.

### Materials and Methods

In brief, 40-day-old male Cobb 500 broilers were placed in floor pens, with 9 replicate pens per treatment and 7 treatments total. All birds were fed a commercially representative corn/soy diet over 3 phases and had ad lib access to water. Treatment groups were as follows: unchallenged control (UC), challenged control (CC), CC+BE (betaine; inclusions were betaine (lkg/ptt), Enviva® EO (cinnamaldehyde and thymol essential oils; 100 g/ptt); CC+BE+DUAL; CC+BE+NCFM; CC+50% BE+DUAL; CC+ Betaine (lkg/ptt)+DUAL. DUAL refers to a DFM combination of L. acidophilus NCFM and B. animalis subsp. lactis B1-04. BE was administered via the feed, while DFMs were administered every other day via the water line to deliver birds received 10⁹ CFU for D1-28 of the study. All diets contained 750 FTU Axtra® PHY. On day 18-20 birds were challenged via oral gavage with 1.0 ml of fluid thioglycolate (FTG) broth containing approximately 1×10⁸ CFU/ml Clostridium perfringens (Cp; netB+ strain) to induce NE. Control birds will be inoculated once daily from 18-20 days of age with sterile FTG. BWG, FI and FCR were recorded on days 0, 14, 21, 28 and 42 of the study. NE lesion scores were conducted on D28 (0-4).

### Results

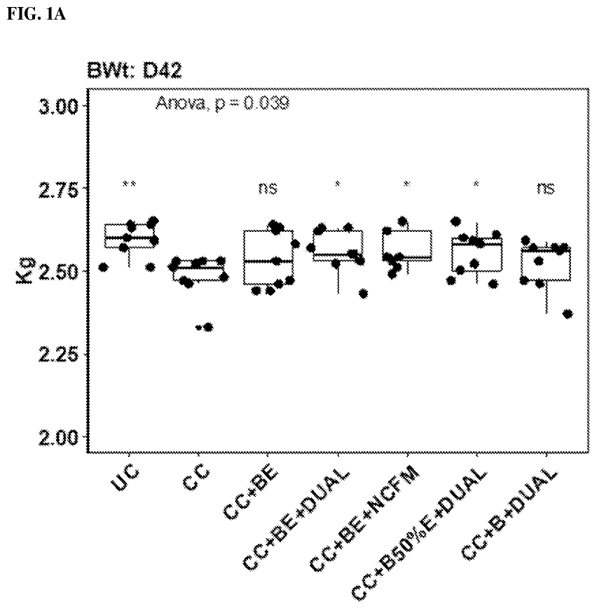

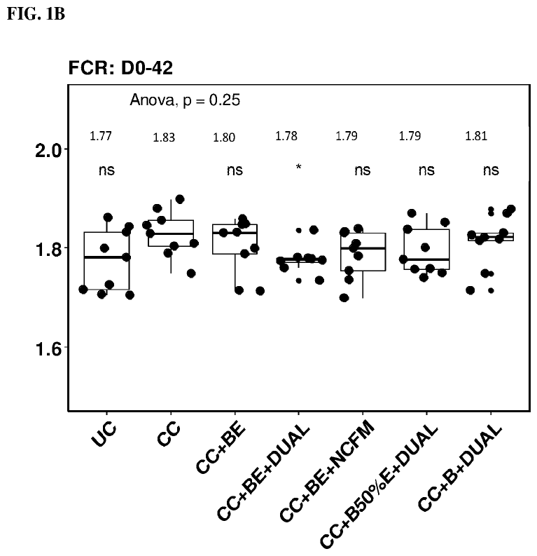

In brief, and as shown in FIG. 1A and FIG. 1B, the results demonstrate that BE alone is not enough, at the levels tested, to reduce NE effects, while there was a significant (p<0.05) reduction in D42 mortality for BE+NCFM. The most positive effect on bird lesion scores was seen with BE+NCFM or BE+DUAL combinations, whereby no birds scored a lesion score above 1, versus 3 birds scoring a lesion score of 2 in BE only treatment. Furthermore, as BE dose was reduced to 50% (500 g and 50 g of betaine and EO respectively) the more birds scored a lesion score of above 1.0, while removal of EO resulted in a dose response increase in more moderate lesions.

Such findings were translated to final BW (D42 with significant (p<0.05) improvements in BW for BE+NCFM or DUAL as well as 50% BE+DUAL versus CC, but only numerical (P>0.05) improvements in BW for Betaine+DUAL combination. Thus, this example demonstrated that it is the precise combination of actives which delivered the desired outcome of reduced negative effects of NE. Without being bound to theory, it is believed that these observed improvements are likely via reduction of Cp levels in vivo, prevention of clostridial blooms, quorum sensing, and subsequent reduced Net-B toxin production as measured in the study per Example 3, infra.

### Example 2: Not all Active Agents are Capable of Reducing the Negative Effects of Necrotic Enteritis

Example 2 surprisingly demonstrates that not all actives which have expected anti-microbial activities, when used as part of the combination, demonstrate the ability to reduce NE onset. Glucose oxidase (GOX) is reported in the literature to have anti-Cp effects and is a commonly used food enzyme due to its antimicrobial activity via production of hydrogen peroxide.

### Materials and Methods

In this example, 2160-day-old Male Cobb 500 broilers were allocated to one of 6 treatments pens with 8 replicate pens/treatment (45 birds per pen). All birds were fed a commercially representative corn/soy diet over 3 phases and had ad lib access to water. All diets contained 750 FTU Axtra PHY. Treatment groups were as follows; unchallenged control (UC), challenged control (CC), CC+ BEG (betaine (lkg/ptt), Enviva® EO (100 g/ptt, GOX (100 g/ptt))+NCFM and B1-04 (DUAL); CC+BEG+NCFM; CC+BE+DUAL; CC+BE+NCFM. BEG actives were administered via the feed, DFMs were administered daily via the water line to deliver birds received 10⁹ CFU daily for D1-28 of the study. Birds received coccidiosis vaccine on Day 0 and all birds except UC group received 10⁸-9 CFU field Cp strain (Cp4) via oral gavage on days 19, 20 and 21. Such challenge resulted in mild NE onset. Three birds per pen were sacrificed on days 21 and 28 for NE lesion scoring (0-4) and evaluation of gut permeability (FITC-Dextran assay and tight junction protein gene expression). Feed intake, bodyweight gain and FCR was calculated on D14, 21, 28 and 35 days. Mortality was recorded daily.

### Results

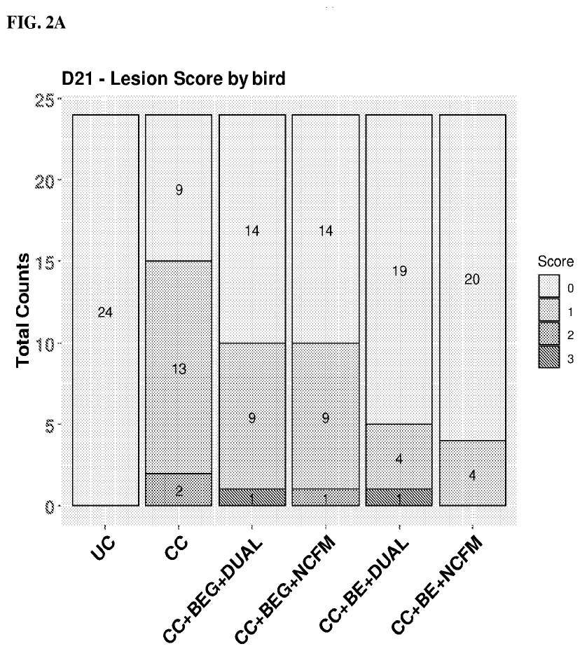

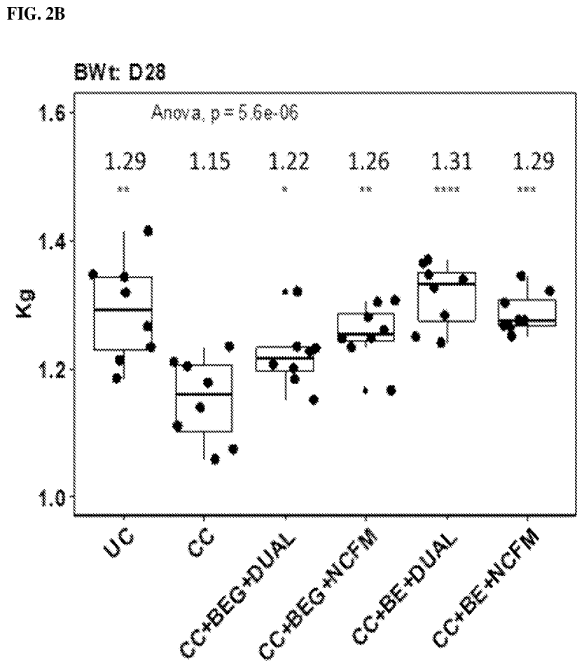

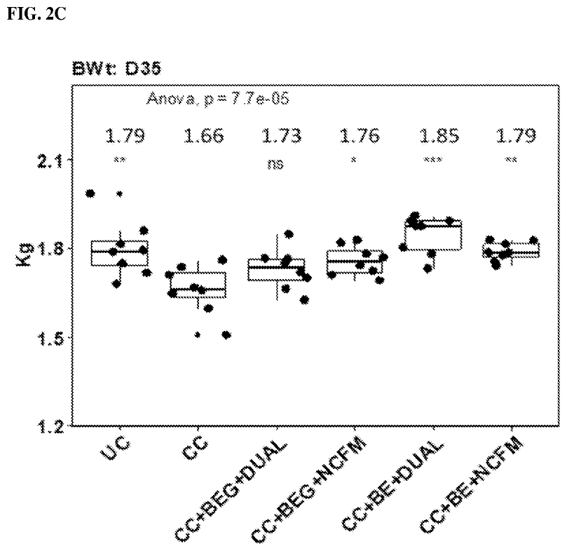

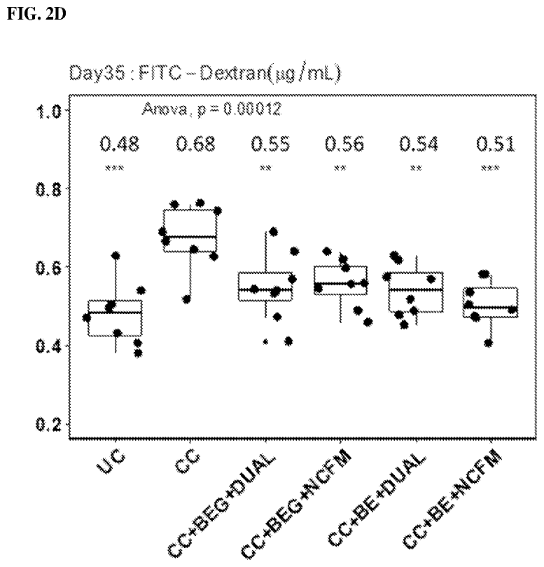

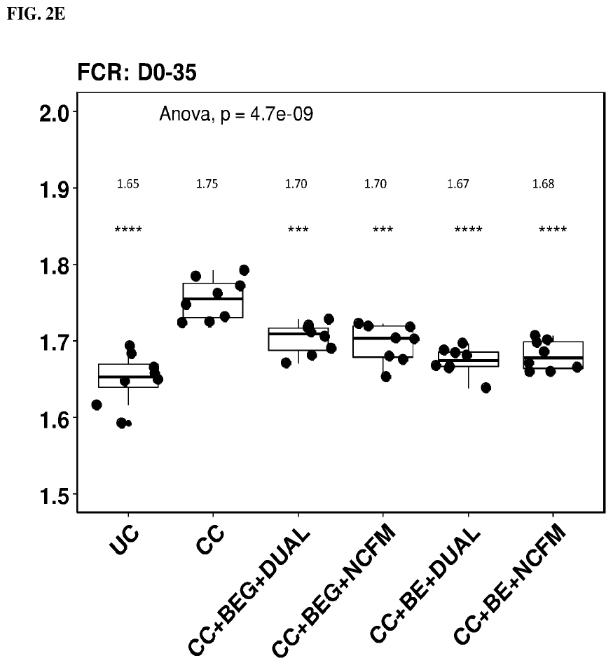

Lesion scores at D21 demonstrated that all combinations of actives reduced NE lesion scores (FIG. 2A) compared to the CC, however the greatest reduction in NE lesion scores was observed in the birds which received only the betaine, EO and DFM combinations, irrespective of whether there was one or two DFM strains included in the combination. The same result was seen in evaluations of gut permeability using the FITC-DEXTRAN assay at D28 (FIG. 2D), demonstrating improved gut integrity. These results were translated to the bodyweights of the birds at D28 (FIG. 2B) and D35 (FIG. 2C). For example, birds receiving BEG+DUAL had increased BW's of 69 grams compared to CC, whereas the same combination minus the GOX increased BW by 185 grams at D35. Thus, birds receiving only BE+ DFM had the highest BW's and were significantly different (P<0.05) to the CC. Such performance improvements were observed in the FCR at D35 (FIG. 2E); BEG+NCFM 5.18 improvement in FCR versus 8.15 points for the same combination minus GOX.

Thus, this example demonstrated that not all antimicrobial actives have equal positive impact of NE onset.

### Example 3: Reduction of C. perfringens and netB Expression in Treated Animals

This Example shows that certain active agents are capable of reducing the levels of C. perfringens and netB expression during times of NE challenge.

### Materials and Methods

In brief, 1680 male Cobb 500-day-old chicks were allocated to one of 7 treatments with 8 replicate pens per treatment (30 bird/pen). Treatments were as follows: unchallenged control (UC), challenged control (CC), CC+BE (inclusions were betaine (lkg/ptt), Enviva® EO (100 g/ptt)); CC+BE+3 strains DFM; CC+BE+DUAL; CC+BE+NCFM; CC+BEG (betaine (lkg/ptt), Enviva® EO (100 g/ptt, GOX (100 g/ptt))+NCFM. DUAL refers to a DFM combination of L. acidophilus NCFM and B. animalis subsp. lactis B1-04. BE and BEG actives were administered via the feed, DFMs were administered daily via the water line to deliver birds received 10⁹ CFU daily for D1-28 of the study. All diets contained 750 FTU Axtra® PHY.

On Study Day 7, birds in all treatments, except UC, received a 10×recommended dose of the Advent coccidiosis vaccine to predispose to NE. On D17 these birds, received ˜10⁸ CFU C. perfringens field isolate via the feed. Bird performance parameters were measured on days 0,14,21,28 and 42 days. Birds were sacrificed on D21 for NE lesion scores, and ileal swabs collected for C. perfringens quantification and netB expression via Q-PCR.

### Results

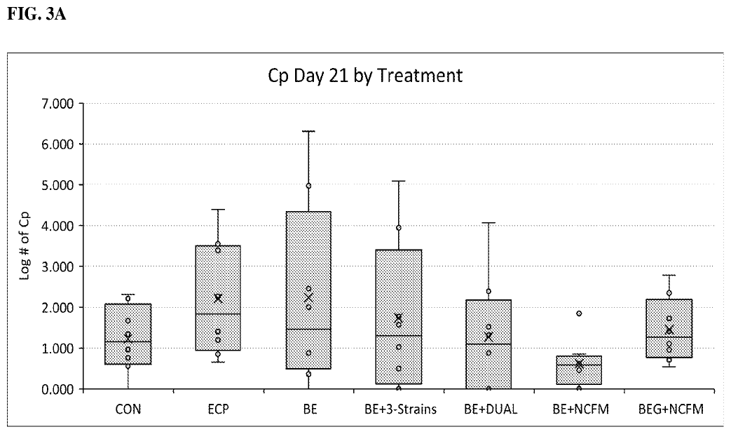

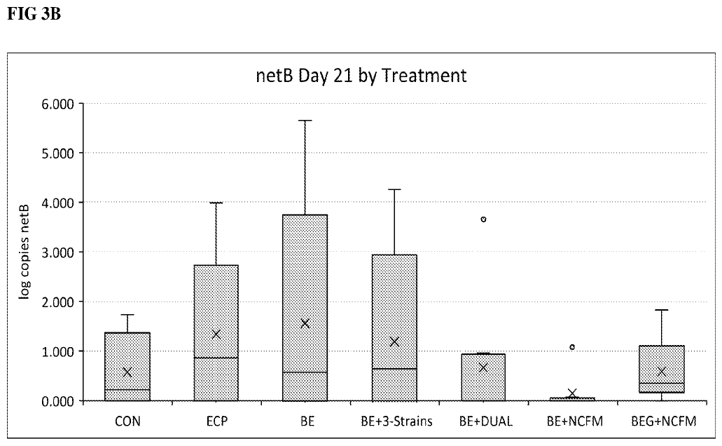

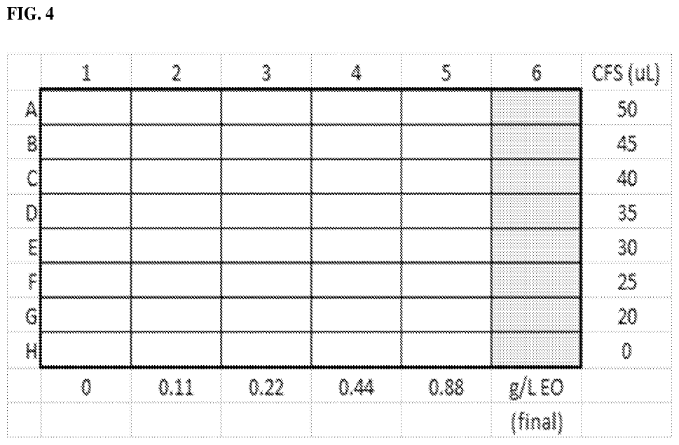

Bird performance was improved either numerically (P>0.05) or significantly (P<0.05) with additive supplementation. Microbial analysis demonstrates that the combination of BE+DUAL or NCFM significantly reduced the levels of C. perfringens and netB expression (FIG. 3A, FIG. 3B, FIG. 4A, and FIG. 4B).

In summary, this example showed that by reducing C. perfringens levels and reducing the amount of microbial toxin produced, there is consequently less damage to the intestinal tract, thus maintaining bird performance to levels like the UC.

### Example 4: Synergistic Improvements when Combining Essential Oils CFS from Probiotics Against Clostridium perfringens

The objective of this experiment was to evaluate Enviva® EO (Essential Oils) and potential synergies with the cell free supernatant (CFS) from proposed blend combinations of probiotics, Bifidobacterium animalis subsp. lactis strain B1-04 and Lactobacillus acidophilus strain NCFM, against Clostridium perfringens (CP).

### Materials and Methods

Increasing amounts of CFS of each probiotic and Enviva® EO essential oils were added together in a checkerboard fashion and were inoculated with CP and grown overnight. The percent inhibition against the no treatment control (no CFS and no EO) was then calculated. Briefly, B1-04 and NCFM strains were grown anaerobically at 37° C. for approximately 48 hours in De Man, Rogosa and Sharpe medium (MRS)

The CFS was harvested by pelleting the cells by centrifugation at 8000×g for 10 minutes and filtering the supernatant through a 0.2 um aPES membrane. For the inhibition assay, the wells of a 96-well microtiter plate (Corning Costar #3370, Corning, NY) were filled with 130 μL Brain Heart Infusion medium (BHI).

A 17.6 g/L solution of Enviva® EO was made in sterile water and diluted 50:50 in BHI for a final concentration of 8.8 g/L. Two-fold dilutions were then made in BHI to achieve 10× stock concentrations of 4.4, 2.2, and 1.1 g/L. B1-04 CFS was then added down the rows of the microtiter plate containing the 130 μL BHI as shown in FIG. 4. Into each well of row A, 50 μL CFS were added. Into row B, 45 μL were added. The process continued down the plate in 5 μL decreasing amounts until 20 μL were added to row G. Row H contained no CFS. Twenty microliters of the 10×EO stocks were then added into respective columns. Into column 2, 20 μL of the 1.1 g/L (10×) EO stock were added into each well. Into column 3, 20 μL of the 2.2 g/L stock were added. Into column 4, 20 μL of the 4.4 g/L stock were added. Into column 5, 20 μL of the 8.8 g/L stock were added to each well. Into column 1 (no EO), 20 μl BHI medium were added. Final volumes of each well were brought to 200 μL with MRS. The setup was the same for the NCFM strain except the ranges of CFS were from 5 μL to 35 μL at 5 μL increments.

A single colony of Clostridium perfringens (CP) from a BHI agar plate was inoculated into 200 ul BHI and grown for 3.5 hours to an OD600 of 0.5-0.8. Two microliters of this were added into each well. The plates were covered with a breathable membrane and incubated anaerobically at 37° C. for about 16-18 hours. The optical densities were then read at 600 nm in a BioTek Synergy MX microplate reader (BioTek Instruments, Winooski, VT). The inhibition of CP growth was then calculated as a percent of the zero CFS/zero EO control wells.

### Results

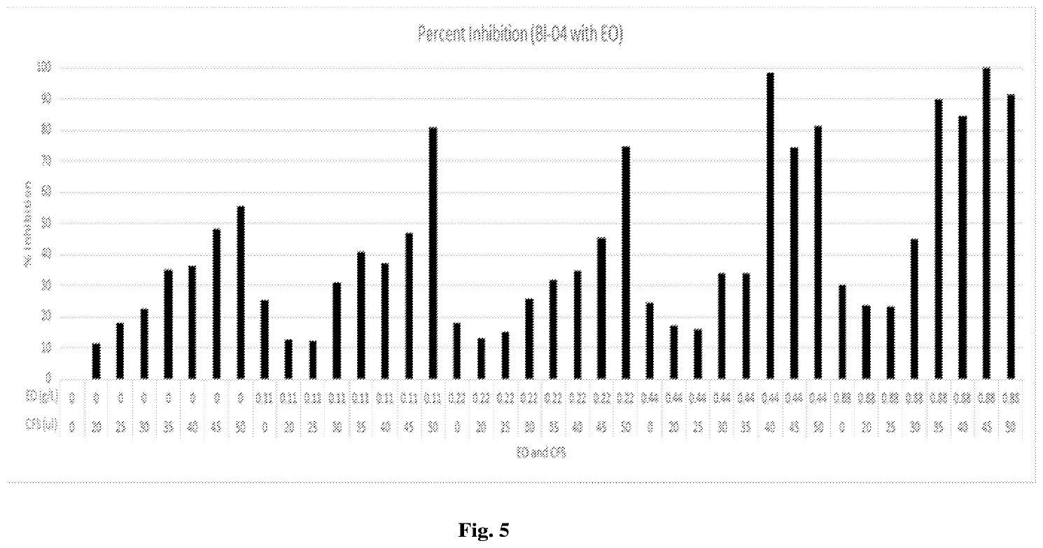

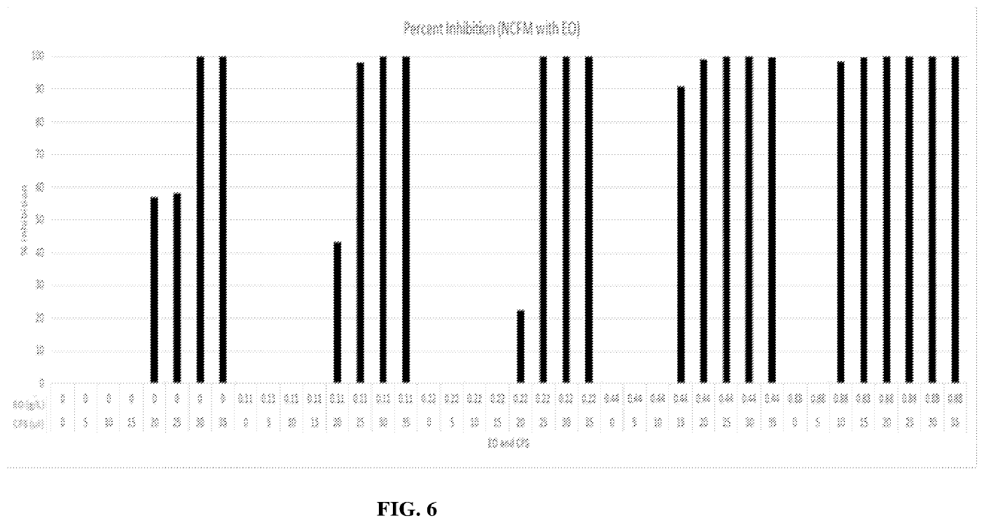

The results show that there was synergy with the two DFM candidates and the Enviva® EO, especially at the higher EO concentrations (FIG. 5 and FIG. 6). For example, for NCFM, no EO with 15 μL CFS had no inhibition of CP. And, 0.44 g/L EO with no CFS also had no CP inhibition. However, 0.44 g/L EO with 15 μL CFS had 91% inhibition. Similar synergies can be seen with other concentrations of CFS and EO with both B1-04 and NCFM.

### Example 5: Modulation of Clostridium perfringens netB Toxin Expression by Addition of Metabolites

This Example uses a novel technique for assessing gene expression in single bacterial cells to identify single cell populations of Clostridium perfringens characterized by high and low netB gene expression, respectively. Genes encoding components of metabolic pathways whose expression were decreased in high netB-expressing cells were identified and these high netB-expressing cells were then supplemented with the products of these metabolic pathways to ascertain effects on netB expression.

### Materials and Methods

Probe Design & Library Generation: To leverage existing microfluidic single cell sequencing platforms, method relying on tagging individual transcripts with DNA probes was devised. This approach required the generation of a large oligonucleotide library complementary to all protein coding sequences within a genome. Multiple DNA regions of 50 bp were chosen from each ORF based on uniqueness as determined by UPS2 software or based on previously published oligonucleotide arrays. These sequences then served as the hybridization regions of ssDNA probes which were designed to target mRNA by sequence complementarity. Probes also contained a 5′ PCR handle for library generation, a Unique Molecular Identifier (UMI), and a 3′ poly adenosine tail (A₃₀) for retrofitting prokaryotic transcripts to the 10× Genomics Chromium Single Cell 3′ system. Multiple probes (complementary to different regions) were designed for each gene to enhance transcript capture efficiency and decrease noise caused by poor hybridization and/or insufficient amplification of any given probe. The complete species library contained 11,723 probes for Clostridium perfringens and targeted 3189 C. perfringens genes.

Libraries were ordered at sub-femtomole quantities from Twist Biosciences and amplified by rolling circle amplification to obtain a sufficient concentration (0.25 mg=10.25 nM/library or approximately 0.35 pM of each probe) for scRNA-seq experiments. Probe libraries were completed by addition of randomized 12 bp UMI sequences and a poly-A tail and purified by PAGE. Completed libraries had a uniform coverage of probes.

Before microfluidic encapsulation, bacteria were fixed in 1% paraformaldehyde and permeabilized. Permeabilized bacteria were incubated with their corresponding DNA probe library. Non-hybridized probes were washed away. Next, the bacteria were run through a 10× controller, where the DNA probes were captured and barcoded. The resulting libraries were sequenced, preprocessed with custom scripts and analyzed with the standard CellRanger pipeline and the Seurat analysis package.

Clostridium perfringens: Clostridium perfringens strain 25037-CP01 was grown anaerobically at 37° C. in BHI media supplemented with 0.05% cysteine-HCL and, when indicated, 0.625 mg/ml final concentration of ornithine, aspartic acid, or arginine. Anaerobic conditions were maintained using a gas-pack and anaerobic culture boxes. The oxygen indicator on all experimental replicates indicated the absence of oxygen contamination in the chamber.

HT-29 Human colorectal adenocarcinoma cell line: HT-29 cells were obtained from ATCC and cultured in McCoy's 5A medium (1.5 mM L-glutamine; 2200 mg/L sodium bicarbonate) supplemented with 10% certified FBS (complete media). Cells were cultured in a T75 flask in a 37° C. incubator containing 5% C02 and 95% humidity until cells reached 80-90% confluency. Cells were subcultured by detaching cells using 0.05% trypsin, centrifuged and resuspended in 10 mL of complete media. New flasks were seeded 1:10 and incubated under the same conditions above or cells were seeded into a 96 well plate for experiments as described.

Cytotoxicity assay: Cytotoxicity was investigated for conditioned media from C. perfringens cultures that was used in Western Blot analysis. In a 96 well plate, 2×104 HT-29 cells were seeded in each well and incubated for two days in a 37° C. incubator containing 5% C02 and 95% humidity. Media was replaced and 5 μL of conditioned C. perfringens supernatant was added to respective wells and cells were incubated overnight in a 37° C. incubator containing 5% C02 and 95% humidity. Following incubation, images were acquired using an EVOS FLoid microscope and cytotoxicity measured using Cell Proliferation Assay Kit (BioVision) according to manufacturer's protocol. Briefly, 20 μL of a 1:50 (1:500 final) dilution of nuclear dye was added. The plate was incubated at room temperature on a plate shaker, 100 rpm, for 15 mins. Cell were lysed and 480/538 nm fluorescence measured using a plate reader (Tecan).

### Results

It was sought to determine whether heterogenous expression of virulence genes in a bona-fide pathogen could be identified using a single cell transcriptional analysis. For this purpose, toxin production in Clostridium perfringens, the causative agent of necrotic enteritis was examined. The major toxin associated with necrotic enteritis, NetB, is a secreted β-barrel pore-forming toxin that has been shown to be the virulence factor directly responsible for pathogenicity in chickens (REFS). Single cell analysis was performed on C. perfringens grown in rich media (BHI, Materials and Methods) to late exponential phase, the time in which toxin is expressed and accumulates in the growth media. While NetB toxin was expressed from all clusters to some basal extent, the differential overexpression of netB was a defining hallmark of one cluster of cells (FIG. 7A, cluster 0)—and NetB was selected as a marker gene with a P-value of at least 0.005 in each independent analysis of 4 biological replicates taken across several different ODs around the transition from exponential to stationary phase (data not shown). Interestingly, cells in clusters that express reduced levels of NetB differentially overexpress genes associated with distinct physiological states, including arginine synthesis genes (FIG. 7A, cluster 2), putative phage genes (FIG. 7A, cluster 4) and purine and pyrimidine synthesis (FIG. 7A, cluster 3).

The presence of cells overexpressing arginine synthesis genes and the gene for an arginine/ornithine antiporter in cluster 2, which expresses diminished levels of toxin gene, prompted speculation as to whether toxin production and the size of the toxin producing population can be controlled by providing specific metabolites involved in arginine biosynthesis. To test this hypothesis the culture media was perturbed by adding the arginine-biosynthesis associated metabolites ornithine, arginine and aspartic acid (FIG. 7B) to the culture media, and found that addition of aspartic acid and, to a lesser extent ornithine and arginine, are able to lower the level of the 33 kDa NetB toxin secreted into the media (FIG. 7C). To confirm the diminished levels of extracellular toxin, a single cell analysis in cultures grown with addition of the three metabolites was performed. Addition of aspartic acid caused a dramatic shift in cell clustering, and a marked reduction of the main toxin producing population was observed in single cell data from this culture (FIG. 7D). The addition of ornithine and arginine caused a smaller but still noticeable shift in cells and a small reduction in NetB expression in cells. Without being bound to theory, the large shift caused by the addition of aspartic acid leads to speculation that aspartate may have effects beyond its contribution to arginine biosynthesis, possibly related to its role in other differentially expressed pathways in the original single cell data including pyrimidine synthesis and aspartate catabolism (FIG. 7A).

In line with the hypothesis that pathogenicity can be controlled by adding metabolites that lower NetB toxin and downregulate the fraction of virulence-expressing cells in the total population, the cytotoxicity of conditioned media from cells grown in the presence of ornithine or aspartic acid using human HT29 mammalian epithelial cells, a cell line commonly used for in-vitro tissue-culture cytotoxicity studies was then tested (FIG. 7E). It was found that addition of 5 μl of culture supernatant of bacteria grown in standard BHI media to a culture of HT29 cells (195 ul) leads to approximately 58% cell death. Consistent with the reduction in NetB levels and the smaller fraction of cells in the virulent state, addition of 5 μl of culture media from bacteria receiving aspartic acid was less toxic to HT29 cells, with less than 10% cell death. Ornithine addition was also slightly less toxic, with approximately 32% cell death. Altogether, the results with C. perfringens demonstrate that toxin production can be differentially expressed by specialized cells, and that pathogenicity can be reduced by providing growth conditions that favor other cell states and thus reduce the fraction of virulent cells in a clonal bacterial population.

### Example 6: Addition of Ammonium Phosphate, Sodium Acetate, or B Vitamins (Vitamin B1, B6, and B12) Lowers Extracellular NetB Levels Produced by Clostridium perfringens

In this Example, data obtained from the single cell transcriptional analysis described in Example 5 was used to determine that Clostridium perfringens cells characterized by high netB gene expression were also characterized by decreased expression associated with phosphate, acetate, or B vitamin metabolism.

### Materials and Methods

Growth of Clostridium perfringens: Clostridium perfringens strain 25037-CP01 was grown anaerobically at 37° C. in BHI media supplemented with 0.05% cysteine-HCL and, when indicated, 0.625 mg/ml final concentration of ornithine, aspartic acid, or other additives. Anaerobic conditions were maintained using a gas-pack and anaerobic culture boxes. The oxygen indicator on all experimental replicates indicated the absence of oxygen contamination in the chamber.

Western Blot analysis: To collect conditioned media from C. perfringens cultures cell cultures in late exponential growth (OD of roughly 0.7-0.8) were pelleted by centrifugation at 4,200×G for 4 minutes. Supernatant was then filtered through a 0.2 uM filter. Filtered conditioned media was diluted 1:10 in dH2O and 5 ul samples were incubated with MES SDS running buffer 10 minutes at 95° C. Samples were loaded in equal volume and run on a 4-12% Bis Tris polyacrylamide gel. PAGE gels were transferred onto an invitrolon 45 uM PVDF membrane that was pre-soaked in methanol using the Xcell-II blot apparatus (invitrogen) as per manufacturer instructions. Toxin NetB (33Kd) was detected using custom polyclonal rabbit antibodies and the WesternBreeze rabbit chromogenic Western Blot kit (Invitrogen). All experiments were done using at least biological duplicates and technical triplicates on numerous independent days and representative images were selected.

### Results

Western blots detecting NetB toxin demonstrate that the level of extracellular NetB toxin was reduced when metabolites ammonium phosphate, sodium acetate, or B vitamins (Vitamin B1, B6, and B12) were added to a culture of Clostridium perfringens as compared to extra cellular toxin detected when grown in un-supplemented growth media (BHI). As seen in FIG. 8, the ammonium phosphate band is lighter than the band for the unsupplemented BHI media. As also seen in FIG. 8, the BHI band is darker than bands from media to which Na-acetate, Vitamin B1, Vitamin B6, or Vitamin B12 were added. Accordingly, based on these results, it appears that addition of any of the metabolites ammonium phosphate, sodium acetate, Vitamin B1, Vitamin B6, or Vitamin B12 to Clostridium perfringens, is able to reduce extracellular NetB toxin—the main causative agent of necrotic enteritis.

### Example 7: Addition of Direct Fed Microbials Lowers Extracellular NetB Levels Produced by Clostridium perfringens

Necrotic enteritis (NE) caused by C. perfringens is a reemerging threat to the poultry industry following mounting pressure to reduce antibiotic use. Alternatives to antibiotics are known for apparent inconsistent effects. As a means for improving consistency to develop next generation solutions, the aetiology and characteristics of gut health challenges must be fully elucidated.

In this Example, scRNAseq technology described in Example 5 was used to analyze and decipher the effect of the secretomes of two Direct Fed Microbials (DFMs) L. acidophilus strain NCFM and the Bifidobacterium animalis subsp. lactis strain B1-04 strain, on the production of NetB (the pore-forming toxin considered as the main virulence factor among a variety of different toxins) and the cytotoxicity of a pathogenic (or NE inducing) C. perfringens strain. The NetB expression analysis was performed as in Examples 5 and 6.

### Results

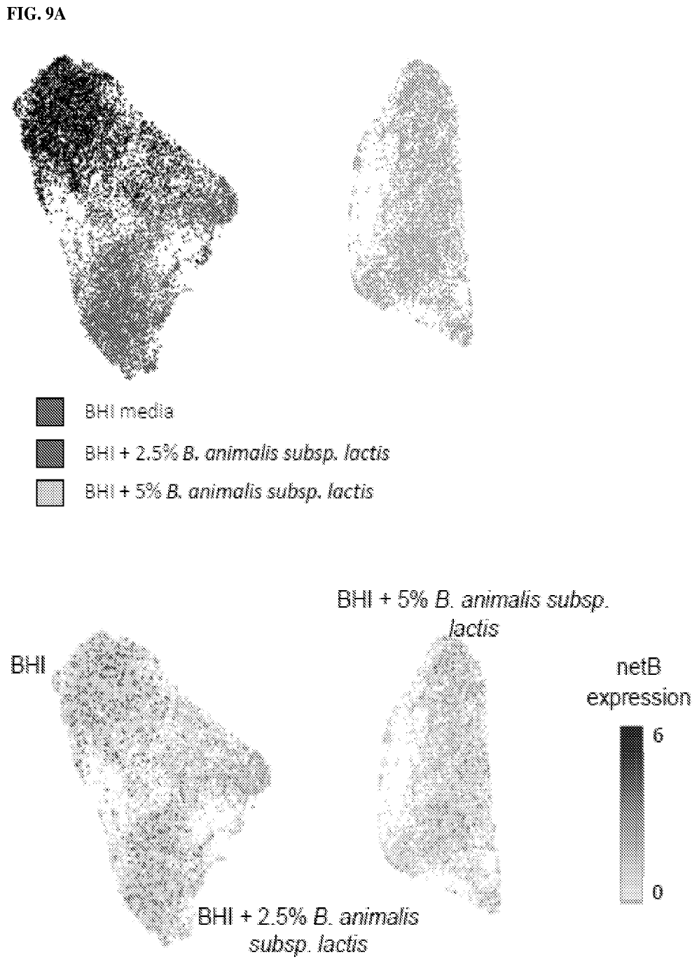

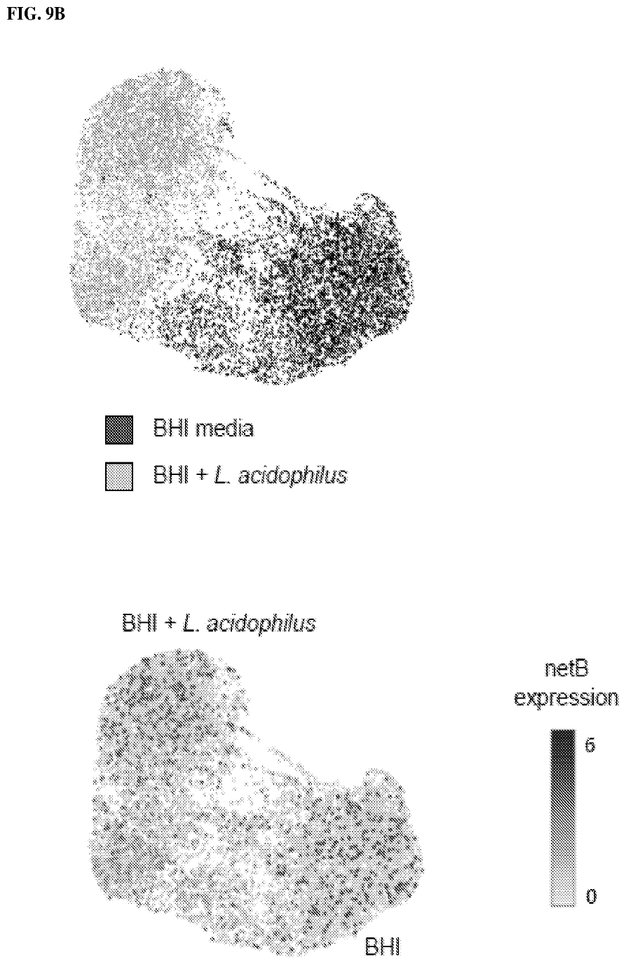

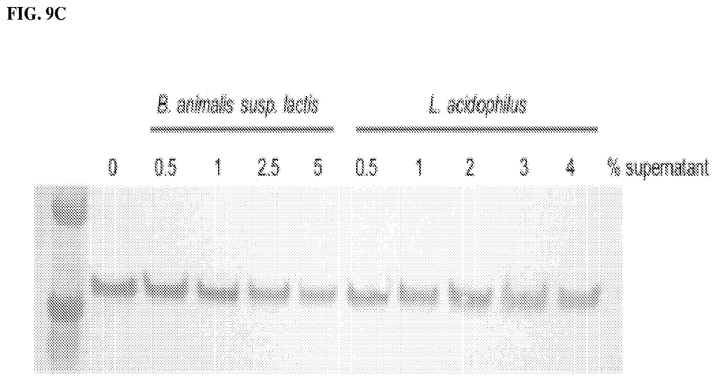

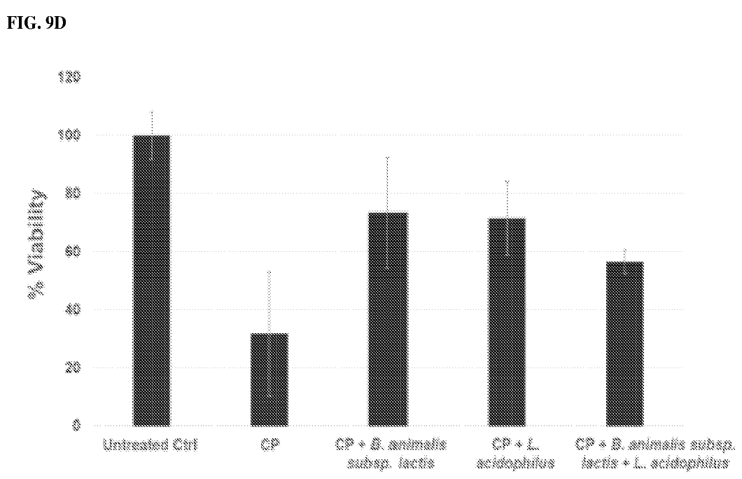

The combined secretomes of both strains reduced production of NetB and overall cytotoxicity of C. perfringens. Treating HT-29 cells with supernatant from C. perfringens grown in the presence of both DFM secretomes reduced C. perfringens cytotoxicity by 60% (FIG. 9D; p-value <0.05). To better understand the effect of the DFM secretomes on the biology of C. perfringens and regulation of pathogenicity, the novel scRNAseq method disclosed in Example 5 was used to investigate the transcriptome of single cells after growth in the presence and absence of the DFM secretome.

Heterogeneous gene expression in C. perfringens populations, with the netB toxin gene being primarily expressed by a subset of cells was shown. Further shown was that the B. animalis secretome changed overall gene expression and biological architecture of C. perfringens population with an 8-fold reduction in netB expression (FIG. 9A; p-value <6×10⁻⁷).

Heterogeneous gene expression in C. perfringens populations, with the netB toxin gene being primarily expressed by a subset of cells was shown. Further shown was that the L. acidophilus secretome changed overall gene expression and biological architecture of C. perfringens population and was associated with a reduction in netB expression (FIG. 9B).

Western blots detecting NetB toxin demonstrate that the level of extracellular NetB toxin was reduced when secretomes from B. animalis and L. acidophilus were added to a culture of Clostridium perfringens as compared to extra cellular toxin detected when grown in un-supplemented growth media (BHI). As seen in FIG. 9C, the band corresponding to NetB toxin is lighter upon increasing amounts of B. animalis secretomes than the band for the unsupplemented BHI media. As also seen in FIG. 9C, the BHI band is darker than bands from media to which increasing amounts of L. acidophilus secretome was added. Accordingly, based on these results, it appears that addition of any of the secretomes from B. animalis or L. acidophilus to Clostridium perfringens, is able to reduce extracellular NetB toxin—the main causative agent of necrotic enteritis

In line with the hypothesis that pathogenicity can be controlled by adding bacteria secretomes that lower NetB toxin and downregulate the fraction of virulence-expressing cells in the total population, the cytotoxicity of conditioned media from cells grown in the presence of B. animalis or L. acidophilus secretomes using human HT29 mammalian epithelial cells, a cell line commonly used for in-vitro tissue-culture cytotoxicity studies was then tested (FIG. 9D). It was found that addition of 5 μl of culture supernatant of bacteria grown in standard BHI media to a culture of HT29 cells (195 μl) leads to approximately 65% cell death. Consistent with the reduction in NetB levels and the smaller fraction of cells in the virulent state, addition of 5 μl of culture media from bacteria receiving B. animalis or L. acidophilus secretome was less toxic to HT29 cells, with less than 30% cell death. The combination of B. animalis and L. acidophilus was also slightly less toxic, with approximately 44% cell death.

Altogether, the results with C. perfringens demonstrate that toxin production can be differentially expressed by specialized cells, and that pathogenicity can be reduced by providing growth conditions that favor other cell states and thus reduce the fraction of virulent cells in a clonal bacterial population.

We claim:

1. A feed additive composition comprising or consisting essentially of a direct fed microbial (DFM) comprising Bifidobacterium animalis subsp. lactis and/or a Lactobacillus acidophilus.

2. The feed additive composition of claim 1, further comprising or consisting essentially of an osmoregulator.

3. The feed additive composition of claim 1 or claim 2, further comprising or consisting essentially of at least one essential oil.

4. The feed additive composition of any one of claims 1-3, further comprising or consisting essentially of one or more enzyme selected from the group consisting of protease, xylanase, beta-glucanase, phytase, and amylase.

5. The feed additive composition of claim 4, wherein the enzyme is encapsulated or in the form of a granule or is freeze dried.

6. The feed additive composition of any one of claims 1-5, comprising or consisting essentially of Bifidobacterium animalis subsp. lactis strain B1-04.

7. The feed additive composition of any one of claims 1-6, comprising or consisting essentially of Lactobacillus acidophilus strain NCFM.

8. The feed additive composition of any one of claims 1-7, wherein the osmoregulator comprises betaine.

9. The feed additive composition of any one of claims 1-8, wherein the at least one essential oil comprises cinnamaldehyde, carvacol, and/or thymol.

10. The feed additive composition of any one of claims 1-9, further comprising or consisting essentially of at least one additional DFM.

11. The feed additive composition of any one of claims 1-10, further comprising or consisting essentially of one or more of aspartic acid (aspartate), ornithine, arginine, phosphate, acetate, and/or a B vitamin.

12. The feed additive composition of any one of claims 1-11, wherein the B vitamin is one or more of vitamin B₁, B₆, and/or B₁₂.

13. The feed additive composition of any one of claims 1-12, wherein at least one component of the composition is formulated for water line delivery.

14. An animal feed or premix comprising the feed additive composition of any one of claims 1-12.

15. A method for treating or preventing necrotic enteritis in a subject in need thereof, comprising administering an effective amount of the feed additive composition of any one of claims 1-13 or the animal feed or premix of claim 14 to the subject.

16. The method of claim 15, wherein the subject is poultry or swine.

17. The method of claim 15 or claim 16, wherein the poultry is a broiler or a layer or a turkey.

18. The method of claim 15 or claim 16, wherein the swine is a piglet, a growing pig, or a sow.

19. The method of any one of claims 15-18, wherein said method reduces or prevents necrotic enteritis intestinal lesions.

20. The method of any one of claims 15-19, wherein said method further reduces feed conversion ratio, increases feed efficiency, reduces mortality, increases final slaughter weight, or increases weight gain in the subject compared to a subject that has not been administered an effective amount of the feed additive composition of any one of claims 1-13 or the animal feed or premix of claim 14.

21. The method of claim 20, wherein the subject has clinical or subclinical necrotic enteritis.

22. The method of any one of claims 15-21, wherein said method further reduces expression of Clostridium perfringens necrotic enteritis B-like toxin (NetB).

23. The method of any one of claims 15-22, wherein the feed additive composition is administered by water line.

24. The method of any one of claims 15-23, wherein said administration is performed without co-administration of an antibiotic to the subject.

25. A method for treating or preventing coccidiosis in a subject in need thereof, comprising administering an effective amount of the feed additive composition of any one of claims 1-13 or the animal feed or premix of claim 14 to the subject.

26. The method of claim 25, wherein the subject is poultry.

27. The method of claim 25 or claim 26, wherein the poultry is a broiler or a layer.

28. The method of any one of claims 25-27, wherein said method reduces feed conversion ratio, increases feed efficiency, reduces mortality, increases final slaughter weight, or increases weight gain in the subject.

29. The method of any one of claims 25-28, wherein said method reduces one or more intestinal Eimeria species.

30. The method of any one of claims 25-29, wherein at least one component of the feed additive composition is administered by water line.

31. A method for decreasing necrotic enteritis B-like toxin (NetB) expression in Clostridium perfringens comprising contacting a C. perfringens cell with one or more of aspartic acid (aspartate), ornithine, arginine, phosphate, acetate, a B vitamin, and/or the secretomes of one or both of B. animalis or L. acidophilus.

32. The method of claim 31, wherein the B vitamin is one or more of vitamin B₁, B₆, and/or B₁₂.

33. The method of claim 31 or claim 32, wherein the B. animalis is Bifidobacterium animalis subsp. lactis strain B1-04 and/or the L. acidophilus is Lactobacillus acidophilus strain NCFM.

34. The method of any one of claims 31-33, wherein the C. perfringens cell is located in the gut of poultry.

35. The method of claim 34, wherein the poultry is a chicken, quail, duck, goose, emu, ostriche, pheasant, or turkey.

36. The method of claim 35, wherein the chicken is a broiler or a layer.

37. The method of any one of claims 31-36, further comprising contacting the C. perfringens cell with one or more of an osmoregulator and/or at least one essential oil.

38. The method of claim 37, wherein the osmoregulator comprises betaine.

39. The method of claim 37 or claim 38, wherein the at least one essential oil comprises cinnamaldehyde, carvacol, and/or thymol.

40. A method for decreasing necrotic enteritis B-like toxin (NetB) expression in Clostridium perfringens in a subject in need thereof comprising or consisting essentially of administering an effective amount of the feed additive composition of any one of claims 1-13 or the animal feed or premix of claim 14 to the subject, wherein the C. perfringens cell is located in the gut of the subject.

41. The method of claim 40, wherein the subject is poultry or swine.

42. The method of claim 40 or claim 41, wherein the poultry is a broiler or a layer or a turkey.

43. The method of claim 40 or claim 41, wherein the swine is a piglet, a growing pig, or a sow.

44. The method of any one of claims 40-43, wherein said method reduces or prevents necrotic enteritis intestinal lesions.

45. The method of any one of claims 40-44, wherein said method further reduces feed conversion ratio, increases feed efficiency, reduces mortality, increases final slaughter weight, or increases weight gain in the subject compared to a subject that has not been administered an effective amount of the feed additive composition of any one of claims 1-13 or the animal feed or premix of claim 14.

46. The method of claim 45, wherein the subject has clinical or subclinical necrotic enteritis.

47. The method of any one of claims 40-46, wherein the feed additive composition is administered by water line.

48. The method of any one of claims 40-47, wherein said administration is performed without co-administration of an antibiotic to the subject.
